(19) United States
(12) Patent Application Publication
(10) Pub. No.: US 2024/0357529 A1
(43) Pub. Date: Oct. 24, 2024

(54) FRAMEWORK AND SIGNALING FOR MULTI-TIME ADVANCE FOR MULTIPLE TRANSMISSION/RECEPTION POINTS

(71) Applicant: Telefonaktiebolaget LM Ericsson (publ), Stockholm (SE)

(72) Inventors: Andreas NILSSON, Göteborg (SE); Siva MURUGANATHAN, Stittsville (CA); Shiwei GAO, Nepean (CA); Claes TIDESTAV, Bålsta (SE)

(21) Appl. No.: 18/688,179

(22) PCT Filed: Sep. 1, 2022
(86) PCT No.: PCT/IB2022/058232

§ 371 Date: Feb. 29, 2024

Related U.S. Application Data
(60) Provisional application No. 63/240,717, filed on Sep. 3, 2021.

(51) Int. Cl. H04W 56/00

(52) U.S. Cl. CPC H04W 56/0045; H04W 56/0005

(57) ABSTRACT

A network node configured to communicate with a wireless device (WD) is described. The network node comprises processing circuitry configured to determine a configuration for the WD to perform at least one timing advance (TA) action for first and second groups of uplink physical channels and reference signals. The determined configuration includes information about first and second TA groups (TAGs). The first and second TAGs are associated with the first and the second groups of uplink physical channels and reference signals, respectively. The first and second TAGs are for a same serving cell. The network node further includes a radio interface in communication with the processing circuitry. The radio interface is configured to transmit the determined configuration to the WD.

### TECHNICAL FIELD

The present disclosure relates to wireless communications, and in particular, to framework and signaling for multiple timing advance (multi-TA) for multiple transmission/reception points (mTRP).

### BACKGROUND

The Third Generation Partnership Project (3GPP) has developed and is developing standards for Fourth Generation (4G) (also referred to as Long Term Evolution (LTE)), Fifth Generation (5G) (also referred to as New Radio (NR)), and Sixth Generation (6G) wireless communication systems. Such systems provide, among other features, broadband communication between network nodes (NNs), such as base stations, and mobile wireless devices (WD) such as user equipment (UE), as well as communication between network nodes and between WDs.

### TCI State

### DL TCI States

Several signals can be transmitted from different antenna ports of a same network node (e.g., base station). These signals can have the same large-scale properties such as Doppler shift/spread, average delay spread, or average delay. The antenna ports may be quasi co-located (QCL).

If the WD knows that two antenna ports are QCL with respect to a certain parameter (e.g., Doppler spread), the WD can estimate that parameter based on one of the antenna ports and apply that estimate for receiving signal on the other antenna port. For example, a transmission configuration indicator (TCI) state may indicate a QCL relation between a channel information state reference signal (CSI-RS) for tracking reference signal (TRS) and the physical downlink shared channel (PDSCH) demodulation reference signal (DMRS). When the WD receives the PDSCH DMRS, the WD may use the measurements already made on the TRS to assist the DMRS reception.

Information about what assumptions can be made regarding QCL may be signaled to the WD from the network node. In NR, four types of QCL relations between a transmitted source reference signal (RS) and transmitted target RS may be defined:
Type A: {Doppler shift, Doppler spread, average delay, delay spread}
Type B: {Doppler shift, Doppler spread}
Type C: {average delay, Doppler shift}
Type D: {Spatial Rx parameter}

QCL type D was introduced to facilitate beam management with analog beamforming and is known as spatial QCL. There is currently no definition of spatial QCL, but an interpretation may be that if two transmitted antenna ports are spatially QCL, the WD can use the same Rx beam to receive them. This may be helpful for a WD that use analog beamforming to receive signals, since the WD need to adjust its receiver (RX) beam in some direction prior to receiving a certain signal. If the WD knows that the signal is spatially QCL with some other signal it has received earlier, then the WD can use the same RX beam to also receive this signal. Note that for beam management, although QCL Type D may be useful, it may also be useful to convey a Type A QCL relation for the RSs to the WD, e.g., so that the WD can estimate all the relevant large-scale parameters.

Typically, this is achieved by configuring the WD with a CSI-RS for tracking (TRS) for time/frequency offset estimation. To be able to use any QCL reference, the WD may have to receive it with a sufficiently good signal-to-noise-plus-interference ratio (SINR). In many cases, this means that the TRS may have to be transmitted in a suitable beam to a certain WD.

To introduce dynamics in beam and transmission point (TRP) selection, the WD can be configured through radio resource control (RRC) signaling with M TCI states, where M is up to 128 in frequency range 2 (FR2) for the purpose of PDSCH reception and up to 8 in FR1, depending on WD capability.

Each TCI state may include QCL information, i.e., one or two source downlink reference signals DL RSs, each source RS associated with a QCL type. For example, a TCI state may include a pair of reference signals, each associated with a QCL type, e.g., two different CSI-RSs {CSI-RS1, CSI-RS2} may be configured in the TCI state as {qcl-Type1, qcl-Type2}={Type A. Type D}. That is, the WD can derive Doppler shift, Doppler spread, average delay, delay spread from CSI-RS1 and Spatial Rx parameter (i.e., the RX beam to use) from CSI-RS2.

Each of the M states in the list of TCI states can be interpreted as a list of M possible beams transmitted from the network node or a list of M possible TRPs used by the network node to communicate with the WD. The M TCI states can also be interpreted as a combination of one or multiple beams transmitted from one or multiple TRPs.

Further, a first list of available TCI states may be configured for PDSCH, and a second list of TCI states may be configured for physical downlink control channel (PDCCH). Each TCI state may include a pointer, known as TCI State identifier (ID), which points to the TCI state. The network node may activate via medium access control (MAC) control element (CE) one TCI state for PDCCH (i.e., provides a TCI for PDCCH) and up to eight active TCI states for PDSCH. The number of active TCI states the WD support may be a WD capability, e.g., where the maximum is 8.

Each configured TCI state may include parameters for the quasi co-location associations between source reference signals (CSI-RS or synchronization signal/physical broadcast channel (SS/PBCH)) and target reference signals (e.g., PDSCH/PDCCH DMRS ports). TCI states may also be used to convey QCL information for the reception of CSI-RS.

Assuming a WD may be configured with 4 active TCI states (from a list of totally 64 configured TCI states), 60 TCI states may be inactive for this particular WD (but some may be active for another WD) and the WD need not be prepared to have large scale parameters estimated for those. However, the WD may continuously track and update large scale parameters for the 4 active TCI states by measurements and analysis of the source RSs indicated by each TCI state. When scheduling a PDSCH to a WD, the DCI may include a pointer to one active TCI. The WD may determine which large-scale parameter estimate to use when performing PDSCH DMRS channel estimation and thus PDSCH demodulation.

### UL TCI States

The typical process of using spatial relation for uplink (UL) beam indication in NR may be cumbersome and inflexible. To facilitate UL beam selection for WDs equipped with multiple panels, a unified TCI framework for UL fast panel selection is to be evaluated and introduced in NR Release 17 (Rel-17). Similar to DL, where TCI states may be used to indicate DL beams/TRPs, TCI states may also be used to select UL panels and beams used for UL transmissions (i.e., physical uplink shared channel (PUSCH), physical uplink control channel (PUCCH), and sounding reference signal (SRS)).

Further, UL TCI states may be configured by higher layers (i.e., RRC) for a WD in number of possible ways. In one scenario, UL TCI states may be configured separately from the DL TCI states and each uplink TCI state may contain a DL RS (e.g., non-zero power (NZP) CSI-RS or synchronization signal block (SSB)) or an UL RS (e.g., SRS) to indicate a spatial relation. The UL TCI states can be configured either per UL channel/signal or per BWP such that the same UL TCI states can be used for PUSCH, PUCCH, and SRS. Alternatively, a same list of TCI states may be used for both DL and UL. In other words, a WD may be configured with a single list of TCI states for both UL and downlink (DL) beam indication. The single list of TCI states can be configured either per UL channel/signal or per bandwidth part (BWP) information elements.

### Multi-TRP TCI State Operation

In 3GPP Release 16 (Rel-16), a multi-TRP (multiple-transmission reception point) operation was specified. Multi-TRP may include two modes of operation, single DCI based multi-TRP and multiple DCI based multi-TRP.

In 3GPP NR Release 16, multiple DCI scheduling may be used for multi-TRP operations in which a WD may receive two downlink control information messages (DCIs) via two PDCCHs. Each DCI may schedule a PDSCH/PUSCH. Each PDCCH (that carries each DCI) and PDSCH may be transmitted from the same TRP.

For multi-DCI multi-TRP operation, a WD is to be configured with two control resource set (CORESET pools), each associated with a TRP. Each CORESET pool may be a collection of CORESETs that belong to the same CORESET pool. A CORESET pool index can be configured in each CORESET with a value of 0 or 1. For each CORESET Pool, the same TCI state operation method in terms of activation/deactivation/indication as for described above is assumed.

The other multi-TRP mode, single DCI based multi-TRP (or mTRP), may use two DL TCI states to be associated to one DCI codepoint. That is, when a TCI field codepoint in DCI indicates two TCI states, each TCI state may correspond to a different beam or different TRP.

### Inter-Cell Multi-TRP

In 3GPP Release 17 (Rel-17), the work for multi-TRP done in Rel-16 is being extended to an inter-cell scheme. The mTRP transmission may refer to non-coherent Joint Transmission (NC-JT) over multiple transmission points or panels (TRP). NC-JT may refer to multiple-input multiple-output (MIMO) data transmission over multiple TRPs in which different MIMO layers are transmitted over different TRPs. Two ways of scheduling NC-JT multi-TRP transmission are specified in NR Rel-16: multi-PDCCH based multi-TRP transmission and single-PDCCH based multi-TRP transmission.

### Multi-PDCCH Based Multi-TRP Transmission

An example is shown in FIG. 1, where data are sent to a WD over two TRPs, each TRP carrying one Transport Block (TB) mapped to one code word. When the WD has 4 receive antennas while each of the TRPs has only 2 transmit antennas, the WD can support up to 4 MIMO layers, but each TRP can maximally transmit 2 MIMO layers. In this case, by transmitting data over two TRPs to the WD, the peak data rate to the WD can be increased as up to 4 aggregated layers from the two TRPs can be used. This may be beneficial when the traffic load and thus the resource utilization, is low in each TRP. In this example, a single scheduler is used to schedule data over the two TRPs. One PDCCH may be transmitted from each of the two TRPs in a slot, each PDCCH scheduling one PDSCH. This is referred to as a multi-PDCCH or multi-DCI based multi-TRP scheme in which a WD receives two PDCCHs and the associated two PDSCHs in a slot from two TRPs.

In another scenario shown in FIG. 2, independent schedulers are used in each TRP. In this case, only semi-static to semi-dynamic coordination between the two schedulers can be performed due the non-ideal backhaul, i.e., backhaul with large delay and/or delay variations which are comparable to the cyclic prefix length, or in some cases even longer, such as up to several milliseconds.

In NR 3GPP Rel-16, multi-DCI scheduling may be used for multi-TRP in which a WD may receive two DCIs each scheduling a PDSCH/PUSCH. Each PDCCH and PDSCH/PUSCH may be transmitted from the same TRP. An example is shown FIG. 3, where PDSCH 1 is scheduled by PDCCH 1 from TRP1 and PDSCH 2 is scheduled by PDCCH 2 from TRP2. The two PDSCHs may be fully, partially or non-overlapping in time and frequency. When the two PDSCHs are fully or partially overlapping, a same DMRS resource configuration is assumed with DMRS ports of the two PDSCHs in different CDM groups. Multi-DCI scheduling can also be used to schedule PUSCH towards different TRPs. In the case of PUSCH scheduling, the PUSCH transmissions towards different TRPs may be time-division-multiplexed.

As described above, for multi-DCI operation, a WD may need to be configured with two CORESET pools, each pool associated with a TRP. For the two DCIs in the above example, the DCIs are transmitted in two CORESETs belonging to different CORESET pools (i.e., with CORESETPoolIndex 0 and 1 respectively). The two PDSCHs may belong to two different HARQ processes.

### Single-PDCCH Based Multi-TRP Transmission

For single-PDCCH based multi-TRP transmission, the single PDCCH may be received from one of the TRPs while PDSCH(s) may be received from both TRPs. FIG. 4 shows an example where a DCI received by the WD in PDCCH from TRP1 schedules two PDSCHs. The first PDSCH (PDSCH1) is received from TRP1 and the second PDSCH (PDSCH2) is received from TRP2.

The intercell aspect of 3GPP Rel-17 refers to the case when these two TRPs are associated to different SSB (PCI) s. That is, the TCI state that refers to transmission from TRP 1 or TRP 2 is quasi-collocated (or QCLed) to a reference signal that either may be one of the SSB beams with the PCI belonging to that TRP, or another reference signal like CSI-RS or DMRS that has root quasi-colocation (QCL) assumption to one of the SSB beams with PCI belonging to that TRP.

### 3GPP Rel-17 TCI State Framework

In 3GPP Rel-17, a unified TCI state framework is being considered, which aims to streamline the indication of transmit/receive spatial filter (and other QCL properties) to the WD such as by letting a single TCI state indicate QCL properties for multiple different DL and/or UL signals/channels. Which DL/UL signals/channels that the unified TCI state framework should be applied to are being debated in 3GPP, e.g.:

### Considerations:

In 3GPP Rel-17 unified TCI framework:
Whether downlink (DL) or, if applicable, joint TCI also applies to the following signals. If not, for further study (FFS) any other enhancement over 3GPP Releases 15/16:
   CSI-RS resources for CSI
   Some CSI-RS resources for BM, if so, which ones (e.g., aperiodic, repetition ‘ON’)
   CSI-RS for tracking
Whether uplink (UL) or, if applicable, joint TCI also applies to the following signals
   Some SRS resources or resource sets for BM

The unified TCI state framework may include a three stage TCI state indication (in a similar way as was described above for PDSCH) for all or a subset of all DL and/or UL channels/signals. In the first stage, RRC may be used to configure a pool of TCI states. In the second stage, one or more of the RRC configured TCI states may be activated via MAC-CE signaling and associated to different TCI field codepoints in DCI format 1_1 and 1_2. Finally, in the third stage, DCI signaling may be used to select one of the TCI states (or two TCI states in case separate TCI states are used for DL channels/signals and UL channels/signals) that was activated via MAC-CE.

Further, supporting both joint beam indication (“Joint DL/UL TCI”) and separate DL/UL beam indication (“Separate DL/UL TCI”), as described below. For Joint DL/UL TCI, a single TCI state (which for example can be a DL TCI state or a Joint TCI state) may be used to determine a transmit/receive spatial filter for both DL signals/channels and UL signals/channels. For Separate DL/UL TCI, one TCI state (for example a DL TCI state) can be used to indicate a receive spatial filter for DL signals/channels and a separate TCI state (for example an UL TCI state) can be used to indicate a transmit spatial filter for UL signals/channels.

### Considerations:

With respect to a beam indication signalling medium to support joint or separate DL/UL beam indication, e.g., in 3GPP Rel-17 unified TCI framework, the following is expected to be supported:
Support L1-based beam indication using at least WD-specific (unicast) DCI to indicate joint or separate DL/UL beam indication from the active TCI states.
   The existing DCI formats 1_1 and 1_2 are reused for beam indication.
Support activation of one or more TCI states via MAC CE analogous to 3GPP Releases 15/16:

### Considerations:

With respect to the 3GPP Release 17 unified TCI framework, to accommodate the case of separate beam indication for UL and DL, the following is being considered:
Utilize two separate TCI states, one for DL and one for UL.
For the separate DL TCI:
   The source reference signal(s) in M TCIs provide QCL information at least for WD-dedicated reception on PDSCH and for WD-dedicated reception on all or subset of CORESETs in a CC
For the separate UL TCI:
   The source reference signal(s) in N TCIs provide a reference for determining common UL TX spatial filter(s) at least for dynamic-grant/configured-grant based PUSCH, all or subset of dedicated PUCCH resources in a CC
   Optionally, this UL transmit (TX) spatial filter can also apply to all SRS resources in resource set(s) configured for antenna switching/codebook-based/non-codebook-based UL transmissions
FFS: Whether the UL TCI state is taken from a common/same or separate TCI state pool from DL TCI state

### Time Alignment and Uplink Synchronization in NR

Different WDs in the same cell may typically be located at different positions within the cell and then with different distances to the base station (e.g., NR. gNB). The transmissions from different WDs may suffer from different delays until the transmission reach the network node (e.g., base station). In order to make sure that the Uplink (UL) transmissions from a WD reaches the network node (e.g., the base station) within the corresponding receive window for the network node (e.g., base station), an uplink timing control procedure may be used. This may avoid intracell interference, both between WDs assigned to transmit in consecutive subframes and between WDs transmitting on adjacent subcarriers.

Further, time alignment of the uplink transmissions may be achieved by applying a timing advance at the WD transmitter, relative to the received downlink timing. That is time alignment may be performed to counteract differing propagation delays between different WDs, as shown in FIG. 5 for a network node such as a 3GPP Long Term Evolution (LTE) eNodeB.

In order to achieve the time alignment and/or to obtain UL synchronization, the network node (e.g., base station, gNB, eNB) may derive the Timing Advance (TA) value that the WD may need to use for the UL transmissions in order to reach the network node (e.g., base station) within the receive window. The network node may indicate the TA value to the WD. When the WD first accesses a cell, the WD may use the random-access procedure where the received Msg1 (i.e., the physical random-access channel (PRACH) preamble) is used by the network node (e.g., base station) to determine the WD initial TA to use for UL transmissions in the cell. During the connection, the network node (e.g., base station) may continuously monitor whether the WD needs to advance/delay the UL transmissions, such as in order to compensate for changes in propagation delay. The network node may indicate to the WD if there is a need to change the timing advance value.

When the WD has a connection to several different serving cells, the same TA value can sometimes be used for more than one of those cells, e.g., due to that they are co-located, where the network node has the same distance to a WD, etc. Such cells can then be configured as belonging to the same Timing Advance Group (TAG). The configuration of TAGs may be performed per cell group, i.e., serving cells may be configured as belonging to the same TAG only if they belong to the same cell group (master cell group (MCG) or secondary cell group (SCG)).

In addition, when the WD does not perform any UL transmissions for some time in a serving cell, the TA value that the WD used earlier may no longer be accurate, e.g., due to that the WD has moved and thus have a different propagation delay. If the WD performs an UL transmission using the latest received TA value, the WD may reach the network node (e.g., base station) outside the receive window, i.e., not correctly received by the network node (e.g., base station). The transmission may be interfering with other UL transmissions (from other WDs). A timer timeAlignmentTimer may be configured for each TAG, to indicate how long the WD can consider itself to be uplink time aligned to serving cells belonging to the associated TAG, without receiving any updates to the TA value. The timeAlignmentTimer may indicate for how long the WD may consider a received TA value as a valid value. If the WD does not receive an updated value before timeAlignmentTimer expires, the WD may no longer UL synchronized to the serving cells belonging to the corresponding TAG.

An example of timing advance, with respect to a network node such as a gNB in NR, is described below (e.g., described in 3GPP Technical Specification (TS) 38.300)::

### Timing Advance

In RRC_CONNECTED, the gNB is responsible for maintaining the timing advance to keep the L1 synchronised. Serving cells having UL to which the same timing advance applies and using the same timing reference cell are grouped in a TAG. Each TAG contains at least one serving cell with configured uplink, and the mapping of each serving cell to a TAG is configured by RRC.

For the primary TAG the WD uses the primary cell (PCell) as timing reference. In a secondary TAG, the WD may use any of the activated secondary cells (SCells) of this TAG as a timing reference cell but should not change it unless necessary.

Timing advance updates are signalled by the gNB to the WD via MAC CE commands. Such commands restart a TAG-specific timer which indicates whether the L1 can be synchronised or not: when the timer is running, the Layer 1 (L1) is considered synchronised, otherwise, the L1 is considered non-synchronised (in which case uplink transmission can only take place on PRACH).

### Initial TA and Timing Advance Group (TAG) Configuration

The initial TA is obtained when the WD performs random access e.g., when performing a transition from IDLE (or INACTIVE) to CONNECTED state. After a WD has first synchronized its receiver to the downlink transmissions received from the gNB (e.g., by monitoring the SSBs of the cell the WD wants to access), the initial timing advance is set by the WD transmitting a random-access preamble from which the gNB estimates the uplink timing value contained within the Random Access Response (RAR) message. This allows the timing advance to be configured by the gNB.

Further, the following is an example of an initial TA configuration during a random-access procedure, e.g., as described in 3GPP TS 38.321:

### Random Access Response Reception

Once the Random Access Preamble is transmitted and regardless of the possible occurrence of a measurement gap, the MAC entity will:
[ . . . ]
1> else if a valid (as specified in 3GPP TS 38.213) downlink assignment has been received on the PDCCH for the RA-RNTI and the received TB is successfully decoded:
   [ . . . ]
2> if the Random Access Response reception is considered successful:
3> if the Random Access Response includes a MAC subPDU with RAPID only:
   [ . . . ]
3> else:
4> apply the following actions for the Serving Cell where the Random Access Preamble was transmitted:
5> process the received Timing Advance Command (see clause 5.2);
   [ . . . ]
[ . . . ]

### Maintenance of Uplink Time Alignment

RRC configures the following parameters for the maintenance of UL time alignment:
timeAlignmentTimer (per TAG) which controls how long the MAC entity considers the Serving Cells belonging to the associated TAG to be uplink time aligned.

The MAC entity will:
[ . . . ]
1> when a Timing Advance Command is received in a Random Access Response message for a Serving Cell belonging to a TAG or in a MSGB for an SpCell:
   [ . . . ]
2> else if the timeAlignmentTimer associated with this TAG is not running:
3> apply the Timing Advance Command for this TAG;
3> start the timeAlignmentTimer associated with this TAG;
   [ . . . ]
[ . . . ]

The MAC entity may not perform any uplink transmission on a Serving Cell except the Random Access Preamble and MSGA transmission when the timeAlignmentTimer associated with the TAG to which this Serving Cell belongs is not running. Furthermore, when the timeAlignmentTimer associated with the PTAG is not running, the MAC entity may not perform any uplink transmission on any Serving Cell except the Random Access Preamble and MSGA transmission on the SpCell. [ . . . ]

### MAC Payload for Random Access Response

The MAC RAR is of fixed size as depicted in FIG. 6.2.3-1, and consists of the following fields:
R: Reserved bit, set to “0”;
Timing Advance Command: The Timing Advance Command field indicates the index value TA used to control the amount of timing adjustment that the MAC entity has to apply in TS 38.213. The size of the Timing Advance Command field is 12 bits;
[ . . . ]

The MAC RAR is octet aligned. See FIG. 6: MAC RAR

### Timing Advance Command MAC CE

The Timing Advance Command MAC CE is identified by MAC subheader with LCID as specified in Table 6.2.1-1.

It has a fixed size and consists of a single octet defined as follows (FIG. 6.1.3.4-1):
TAG Identity (TAG ID): This field indicates the TAG Identity of the addressed TAG. The TAG containing the SpCell has the TAG Identity 0. The length of the field is 2 bits;
Timing Advance Command: This field indicates the index value TA (0, 1, 2 . . . 63) used to control the amount of timing adjustment that MAC entity has to apply (as specified in 3GPP TS 38.213). The length of the field is 6 bits.

See FIG. 7 which shows an example Timing Advance Command MAC CE.

### Transmission Timing Adjustments

Upon reception of a timing advance command for a TAG, the WD adjusts uplink timing for PUSCH/SRS/PUCCH transmission on all the serving cells in the TAG based on a value N_{TA, offset} that the WD expects to be same for all the serving cells in the TAG and based on the received timing advance command where the uplink timing for PUSCH/SRS/PUCCH transmissions is the same for all the serving cells in the TAG.

The TAG concept is configured per serving cell within a cell group via RRC. The WD is configured with the IE CellGroupConfig that contains a MAC Cell group configuration (IE MAC-CellGroupConfig) with MAC parameters applicable for the entire cell group. The IE MAC-CellGroupConfig includes a tag configuration (field tag-Config of IE TAG-Config) as defined below:

### CellGroupConfig

The CellGroupConfig IE is used to configure a master cell group (MCG) or secondary cell group (SCG). A cell group comprises of one MAC entity, a set of logical channels with associated RLC entities and of a primary cell (SpCell) and one or more secondary cells (SCells).

CellGroupConfig information element

-- ASN1START
-- TAG-CELLGROUPCONFIG-START
-- Configuration of one Cell-Group:

| | |
|---|---|
| CellGroupConfig ::= | SEQUENCE { |
| cellGroupId | CellGroupId, |
| rlc-BearerToAddModList | SEQUENCE (SIZE(1..maxLC-ID)) OF RLC- |

| | |
|---|---|
| BearerConfig | OPTIONAL, -- Need N |

| rlc-BearerToReleaseList | SEQUENCE (SIZE(1..maxLC-ID)) OF | |
|---|---|---|
| LogicalChannelIdentity | OPTIONAL, -- Need N | |
| mac-CellGroupConfig | | |
| OPTIONAL, -- Need M | | |
| physicalCellGroupConfig | PhysicalCellGroupConfig | |
| OPTIONAL, -- Need M | | |
| spCellConfig | SpCellConfig | OPTIONAL, -- |
| Need M | | |

| sCellToAddModList | | SEQUENCE (SIZE (1..maxNrofSCells)) OF |
|---|---|---|
| SCellConfig | OPTIONAL, -- Need N | |
| sCellToReleaseList | | SEQUENCE (SIZE (1..maxNrofSCells)) OF |

| | |
|---|---|
| SCellIndex | OPTIONAL, -- Need N |

[...]
}

TABLE 1
Parameter field descriptions.
CellGroupConfig field descriptions
[...]
mac-CellGroupConfig
MAC parameters applicable for the entire cell group.

### MAC-CellGroupConfig

The IE MAC-CellGroupConfig is used to configure MAC parameters for a cell group, including DRX.

MAC-CellGroupConfig information element

| -- ASN1START | |
|---|---|
| -- TAG-MAC-CELLGROUPCONFIG-START | |
| MAC-CellGroupConfig ::= | SEQUENCE { |
| [...] | |
| tag-Config | TAG-Config |

OPTIONAL, -- Need M
[...]
}
-- TAG-MAC-CELLGROUPCONFIG-STOP
-- ASN1STOP
[...]

### TAG-Config

The IE TAG-Config is used to configure parameters for a time-alignment group.

TAG-Config information element

-- ASN1START
-- TAG-TAG-CONFIG-START

| | |
|---|---|
| TAG-Config ::= | SEQUENCE { |
| [...] | |
| tag-ToAddModList | SEQUENCE (SIZE (1..maxNrofTAGs)) |

OF TAG OPTIONAL -- Need N

| | |
|---|---|
| } | |
| TAG ::= | SEQUENCE { |
| tag-Id | TAG-Id, |
| timeAlignmentTimer | TimeAlignmentTimer, |
| ... | |
| } | |
| TAG-Id ::= | INTEGER (0..maxNrofTAGs-1) |
| TimeAlignmentTimer ::= | ENUMERATED {ms500, ms750, |

ms1280, ms1920, ms2560, ms5120, ms10240, infinity}
-- TAG-TAG-CONFIG-STOP
-- ASN1STOP

TABLE 2
TAG field descriptors
TAG field descriptions
tag-Id
Indicates the TAG of the SpCell or an SCell, see TS 38.321. Uniquely
identifies the TAG within the scope of a Cell Group (i.e., MCG or SCG).
timeAlignmentTimer
Value in ms of the timeAlignmentTimer for TAG with ID tag-Id, as
specified in 3GPP TS 38.321.

As described above, the TAG configuration may be a list of TAGs (tag-ToAddModList of IE SEQUENCE (SIZE (1 . . . maxNrofTAGs)) OF TAG), each associated to a TAG identifier (tag-Id of IE TAG-Id) and a time alignment Timer value (timeAlignmentTimer of IE TimeAlignmentTimer, whose values may be ms500, ms750, ms1280, ms1920, ms2560, ms5120, ms10240, infinity).

Then, each serving cell configuration can have a TAG identifier associated e.g., SpCell and/or an SCell of the cell group. Two serving cells having configured the same TAG identifier may be assumed by the WD to have the same time alignment timer and belong to the same Time Alignment Group. This configuration may be provided to the WD in each dedicated serving cell configuration IE ServingCellConfig, also part of CellGroupConfig for each serving cell, as shown below:

### ServingCellConfig

The IE ServingCellConfig may be used to configure (add or modify) the WD with a serving cell, which may be the SpCell or an SCell of an MCG or SCG. The parameters may be WD specific but, at least in part, also cell specific (e.g., in additionally configured bandwidth parts). Reconfiguration between a PUCCH and PUCCHless SCell may only supported using an SCell release and add.

ServingCellConfig information element

| -- ASN1START | |
|---|---|
| -- TAG-SERVINGCELLCONFIG-START | |
| ServingCellConfig ::= | SEQUENCE { |
| [...] | |
| tag-Id | TAG-Id, |
| [...] | |
| } | |

TABLE 3
Serving cell configuration descriptors
ServingCellConfig field descriptions
[...]
tag-Id
Timing Advance Group ID, as specified in TS 38.321 [3], which this cell
belongs to.

[...]

| | |
|---|---|
| CellGroupConfig ::= | SEQUENCE { |
| cellGroupId | CellGroupId, |

[...]

| | | |
|---|---|---|
| spCellConfig | SpCellConfig | OPTIONAL, -- |

| | |
|---|---|
| Need M | |
| sCellToAddModList | SEQUENCE (SIZE (1..maxNrofSCells)) |

OF SCellConfig

Serving cell specific MAC and PHY parameters for a SpCell:

| | |
|---|---|
| SpCellConfig ::= | SEQUENCE { |
| [...] | |
| spCellConfigDedicated | ServingCellConfig |
| OPTIONAL, -- Need M | |
| ... | |
| } | |
| SCellConfig ::= | SEQUENCE { |
| [...] | |
| sCellConfigDedicated | ServingCellConfig |

OPTIONAL, -- Cond SCellAddMod
[...]
}
[...]

### Uplink Time Alignment Maintenance

After the WD is configured with its serving cell(s) for a given cell group (e.g., Master Cell Group-MCG and/or Secondary Cell Group-SCG), the WD may obtain the initial TA value via random access response (RAR) and be configured with the association between serving cells and TAG identifiers. The WD may need to maintain the time alignment according to the TA procedure defined in Clause 5.2 in 3GPP TS 38.321. TA is adjusted while the WD is connected to a serving cell either by an explicit MAC CE from the network (e.g., if the network node detects a possible misalignment) and/or by the WD (e.g., when the time alignment timer timeAlignmentTimer for a given TAG expires).

Upon reception of the Timing Advance Command (which is a MAC CE), the WD applies the command (including new value(s)) and start/re-start the TA timer. Further details of the maintenance procedure, after the initial TA is described below:

Timing Advance Group: A group of Serving Cells that is configured by RRC and that, for the cells with a UL configured, using the same timing reference cell and the same Timing Advance value. A Timing Advance Group containing the SpCell of a MAC entity is referred to as Primary Timing Advance Group (PTAG), whereas the term Secondary Timing Advance Group (STAG) refers to other TAGs.

### Maintenance of Uplink Time Alignment

The MAC entity may:
1> when a Timing Advance Command MAC CE is received, and if an N_{TA} (as defined in TS 38.21) has been maintained with the indicated TAG:
2> apply the Timing Advance Command for the indicated TAG;
2> start or restart the timeAlignmentTimer associated with the indicated TAG.
[ . . . ] 1> when a timeAlignmentTimer expires:
2> if the timeAlignmentTimer is associated with the PTAG:
3> flush all HARQ buffers for all Serving Cells;
3> notify RRC to release PUCCH for all Serving Cells, if configured;
3> notify RRC to release SRS for all Serving Cells, if configured;
3> clear any configured downlink assignments and configured uplink grants;
3> clear any PUSCH resource for semi-persistent CSI reporting;
3> consider all running timeAlignmentTimers as expired;
3> maintain N_{TA} (defined in TS 38.211 [8]) of all TAGs.
2> else if the timeAlignmentTimer is associated with an STAG, then for all Serving Cells belonging to this TAG:

3> flush all HARQ buffers;

3> notify RRC to release PUCCH, if configured;

3> notify RRC to release SRS, if configured;

3> clear any configured downlink assignments and configured uplink grants;

3> clear any PUSCH resource for semi-persistent CSI reporting; 3> maintain N_{TA} (defined in TS 38.211 [8]) of this TAG.

When the MAC entity stops uplink transmissions for an SCell due to the fact that the maximum uplink transmission timing difference between TAGs of the MAC entity or the maximum uplink transmission timing difference between TAGs of any MAC entity of the WD is exceeded, the MAC entity considers the timeAlignmentTimer associated with the SCell as expired.

The MAC entity may not perform any uplink transmission on a Serving Cell except the Random Access Preamble and MSGA transmission when the timeAlignmentTimer associated with the TAG to which this Serving Cell belongs is not running. Furthermore, when the timeAlignmentTimer associated with the PTAG is not running, the MAC entity may not perform any uplink transmission on any Serving Cell except the Random Access Preamble and MSGA transmission on the SpCell.

### SUMMARY

Some embodiments advantageously provide methods, systems, and apparatuses for framework and signaling for multi-TA for mTRP.

In one embodiment, a network node is configured to obtain at least one of a first timing advance (TA) information and a second TA information for the WD, where the first and second TA information are for a same serving cell; and determine at least one of that the first TA information is associated with a first value of a first parameter and that the second TA information is associated with a second value of the first parameter.

In one embodiment, a WD is configured to obtain a first timing advance (TA) information and a second TA information, the first and second TA information being for a same serving cell; and determine that the first TA information is associated with a first value of a first parameter and that the second TA information is associated with a second value of the first parameter.

In one aspect, a network node configured to communicate with a wireless device (WD) is described. The network node comprises processing circuitry configured to determine a configuration for the WD to perform at least one timing advance (TA) action for first and second groups of uplink physical channels and reference signals. The determined configuration includes information about first and second TA groups (TAGs). The first and second TAGs are associated with the first and the second groups of uplink physical channels and reference signals, respectively. The first and second TAGs are for a same serving cell. The network node further includes a radio interface in communication with the processing circuitry. The radio interface is configured to transmit the determined configuration to the WD.

In some embodiments, the radio interface is further configured to transmit to the WD at least one of a first TA command, TAC, associated to the first TAG; and a second TAC associated to the second TAG.

In some other embodiments, the first TAC includes first information about a first TA, and the second TAC includes second information about a second TA.

In an embodiment, the first and the second groups of uplink channels and reference signals are transmitted towards a first transmission reception point (TRP) and a second TRP, respectively.

In another embodiment, the first TAG and the second TAG are associated with at least one of a first TA reference timing and a second TA reference timing, respectively; a first TA offset indication and a second TA offset indication, respectively; and a first TA timer and a second TA timer, respectively.

In some embodiments, the first and the second TA offset indications are configured for the WD by the network node.

In some other embodiments, the radio interface is further configured to transmit at least one of a first downlink reference signal from the first TRP; and a second downlink signal from the second TRP, the first and second downlink signals being usable by the WD to determine the first TA reference timing and the second TA reference timing, respectively.

In an embodiment, the determined configuration further includes at least a first control resource set (CORESET) with a first CORESET pool index and a second CORESET with a second CORESET pool index. The first CORESET pool index is associated with the first TAG, and the second CORESET pool index is associated with the second TAG.

In another embodiment, the radio interface is further configured to transmit signaling associated with at least one of the first and second CORESET pool indices. The transmitted signaling is usable by the WD to determine the first TA reference timing for the first TAG associated with the first TRP and the second TA reference timing for the second TAG associated with the second TRP, respectively.

In some embodiments, the first and second groups of uplink physical channels and reference signals are associated with the first and second CORESET pool indices, respectively.

In some other embodiments, the determined configuration further comprises a list of transmission configuration indicator (TCI) states, where each TCI state of the list of TCI states is associated with one of the first and second TAGs.

In an embodiment, each one of the first and second groups of uplink physical channels and reference signals is associated with one TCI state of the list of TCI states.

In another embodiment, the radio interface is further configured to transmit a control element including at least one of a first TA indication and a second TA indication; at least one TAG identifier mapped to one of the first and second TA indications; a first bitfield indicating whether a TA offset is to be updated for at least one of a third TA and a fourth TA; and a second bitfield indicating which one of the third and fourth TAs is to be updated.

In some embodiments, performing the at least one TA action by the WD includes adjusting uplink transmission timing for the first and second group of uplink channels and reference signals in the same serving cell based on the information about the first and the second TAGs, respectively; and transmitting the first and second group of uplink channels and reference signals using the adjusted uplink transmission timing.

In some other embodiments, the radio interface is further configured to transmit third information to the WD about a first TA offset associated with the first TAG and a second TA offset associated to the second TAG.

According to another aspect, a method in a network node configured to communicate with a wireless device (WD) is described. The method comprises determining a configuration for the WD to perform at least one timing advance (TA) action for first and second groups of uplink physical channels and reference signals. The determined configuration includes information about first and second TA groups (TAGs). The first and second TAGs are associated with the first and the second groups of uplink physical channels and reference signals, respectively. The first and second TAGs are for a same serving cell. The method further includes transmitting the determined configuration to the WD.

In some embodiments, the method further includes transmitting to the WD at least one of a first TA command (TAC) associated to the first TAG; and a second TAC associated to the second TAG.

In some other embodiments, the first TAC includes first information about a first TA, and the second TAC includes second information about a second TA.

In an embodiment, the first and the second groups of uplink channels and reference signals are transmitted towards a first transmission reception point (TRP) and a second TRP, respectively.

In another embodiment, the first TAG and the second TAG are associated with at least one of a first TA reference timing and a second TA reference timing. respectively; a first TA offset indication and a second TA offset indication, respectively; and a first TA timer and a second TA timer, respectively.

In some embodiments, the first and the second TA offset indications are configured for the WD by the network node.

In some other embodiments, the method further includes transmitting at least one of a first downlink reference signal from the first TRP; and a second downlink signal from the second TRP, where the first and second downlink signals is usable by the WD to determine the first TA reference timing and the second TA reference timing, respectively.

In an embodiment, the determined configuration further includes at least a first control resource set (CORESET) with a first CORESET pool index and a second CORESET with a second CORESET pool index. The first CORESET pool index is associated with the first TAG, and the second CORESET pool index is associated with the second TAG.

In another embodiment, the method further includes transmitting signaling associated with at least one of the first and second CORESET pool indices. The transmitted signaling is usable by the WD to determine the first TA reference timing for the first TAG associated with the first TRP and the second TA reference timing for the second TAG associated with the second TRP, respectively.

In some embodiments, the first and second groups of uplink physical channels and reference signals are associated with the first and second CORESET pool indices, respectively.

In some other embodiments, the determined configuration further comprises a list of transmission configuration indicator (TCI) states, where each TCI state of the list of TCI states is associated with one of the first and second TAGs.

In an embodiment, each one of the first and second groups of uplink physical channels and reference signals is associated with one TCI state of the list of TCI states.

In another embodiment, the method further includes transmitting a control element including at least one of a first TA indication and a second TA indication; at least one TAG identifier mapped to one of the first and second TA indications; a first bitfield indicating whether a TA offset is to be updated for at least one of a third TA and a fourth TA; and a second bitfield indicating which one of the third and fourth TAs is to be updated.

In some embodiments, performing the at least one TA action by the WD includes adjusting uplink transmission timing for the first and second group of uplink channels and reference signals in the same serving cell based on the information about the first and the second TAGs, respectively; and transmitting the first and second group of uplink channels and reference signals using the adjusted uplink transmission timing.

In some other embodiments, the method further includes transmitting third information to the WD about a first TA offset associated with the first TAG and a second TA offset associated to the second TAG.

According to an aspect, wireless device, WD, configured to communicate with a network node, the WD comprising a radio interface configured to receive a configuration for the WD to perform at least one timing advance (TA) action for first and second groups of uplink physical channels and reference signals. The received configuration includes information about first and second TA groups (TAGs). The first and second TAGs are associated with the first and the second groups of uplink physical channels and reference signals, respectively. The first and second TAGs are for a same serving cell. The WD further includes processing circuitry in communication with the radio interface and configured to perform the at least one TA action based on the received configuration.

In some embodiments, the radio interface is further configured to receive at least one of a first TA command (TAC) associated to the first TAG; and a second TAC associated to the second TAG.

In some other embodiments, the first TAC includes first information about a first TA, and the second TAC includes second information about a second TA.

In an embodiment, the first and the second groups of uplink channels and reference signals are transmitted towards a first transmission reception point (TRP) and a second TRP, respectively.

In another embodiment, the first TAG and the second TAG are associated with at least one of a first TA reference timing and a second TA reference timing, respectively; a first TA offset indication and a second TA offset indication, respectively; and a first TA timer and a second TA timer, respectively.

In some embodiments, the first and the second TA offset indications are configured for the WD by the network node.

In some other embodiments, the radio interface is further configured to receive at least one of a first downlink reference signal from the first TRP; and a second downlink signal from the second TRP. The first and second downlink signals are usable by the WD to determine the first TA reference timing and the second TA reference timing, respectively.

In an embodiment, the received configuration further includes at least a first control resource set (CORESET) with a first CORESET pool index and a second CORESET with a second CORESET pool index. The first CORESET pool index is associated with the first TAG, and the second CORESET pool index is associated with the second TAG.

In another embodiment, the radio interface is further configured to receive signaling associated with at least one of the first and second CORESET pool indices. The transmitted signaling is usable by the WD to determine the first TA reference timing for the first TAG associated with the first TRP and the second TA reference timing for the second TAG associated with the second TRP, respectively.

In some embodiments, the first and second groups of uplink physical channels and reference signals are associated with the first and second CORESET pool indices, respectively.

In some other embodiments, the received configuration further comprises a list of transmission configuration indicator (TCI) states, where each TCI state of the list of TCI states is associated with one of the first and second TAGs.

In an embodiment, each one of the first and second groups of uplink physical channels and reference signals is associated with one TCI state of the list of TCI states.

In another embodiment, the radio interface is further configured to receive a control element including at least one of a first TA indication and a second TA indication; at least one TAG identifier mapped to one of the first and second TA indications; a first bitfield indicating whether a TA offset is to be updated for at least one of a third TA and a fourth TA; and a second bitfield indicating which one of the third and fourth TAs is to be updated.

In some embodiments, performing the at least one TA action by the WD includes adjusting uplink transmission timing for the first and second group of uplink channels and reference signals in the same serving cell based on the information about the first and the second TAGs, respectively; and causing the radio interface to transmit the first and second group of uplink channels and reference signals using the adjusted uplink transmission timing.

In some other embodiments, the radio interface is further configured to receive third information about a first TA offset associated with the first TAG and a second TA offset associated to the second TAG.

According to another aspect, a method in a wireless device (WD) configured to communicate with a network node is described. The method comprises receiving a configuration for the WD to perform at least one timing advance (TA) action for first and second groups of uplink physical channels and reference signals. The received configuration includes information about first and second TA groups (TAGs). The first and second TAGs are associated with the first and the second groups of uplink physical channels and reference signals, respectively. The first and second TAGs are for a same serving cell. The method further includes performing the at least one TA action based on the received configuration.

In some embodiments, the method further includes receiving at least one of a first TA command (TAC) associated to the first TAG; and a second TAC associated to the second TAG.

In some other embodiments, the first TAC includes first information about a first TA, and the second TAC includes second information about a second TA.

In an embodiment, the first and the second groups of uplink channels and reference signals are transmitted towards a first transmission reception point (TRP) and a second TRP, respectively.

In another embodiment, the first TAG and the second TAG are associated with at least one of a first TA reference timing and a second TA reference timing, respectively; a first TA offset indication and a second TA offset indication, respectively; and a first TA timer and a second TA timer, respectively.

In some embodiments, the first and the second TA offset indications are configured for the WD by the network node.

In some other embodiments, the method further includes receiving at least one of a first downlink reference signal from the first TRP; and a second downlink signal from the second TRP. The first and second downlink signals are usable by the WD to determine the first TA reference timing and the second TA reference timing, respectively.

In an embodiment, the received configuration further includes at least a first control resource set (CORESET) with a first CORESET pool index and a second

CORESET with a second CORESET pool index. The first CORESET pool index is associated with the first TAG, and the second CORESET pool index is associated with the second TAG.

In another embodiment, the method further includes receiving signaling associated with at least one of the first and second CORESET pool indices. The transmitted signaling is usable by the WD to determine the first TA reference timing for the first TAG associated with the first TRP and the second TA reference timing for the second TAG associated with the second TRP, respectively.

In some embodiments, the first and second groups of uplink physical channels and reference signals are associated with the first and second CORESET pool indices, respectively.

In some other embodiments, the received configuration further comprises a list of transmission configuration indicator (TCI) states, where each TCI state of the list of TCI states is associated with one of the first and second TAGs.

In an embodiment, each one of the first and second groups of uplink physical channels and reference signals is associated with one TCI state of the list of TCI states. In another embodiment, the method further includes receiving a control element including at least one of a first TA indication and a second TA indication; at least one TAG identifier mapped to one of the first and second TA indications; a first bitfield indicating whether a TA offset is to be updated for at least one of a third TA and a fourth TA; and a second bitfield indicating which one of the third and fourth TAs is to be updated.

In some embodiments, performing the at least one TA action by the WD includes adjusting uplink transmission timing for the first and second group of uplink channels and reference signals in the same serving cell based on the information about the first and the second TAGs, respectively; and causing the radio interface to transmit the first and second group of uplink channels and reference signals using the adjusted uplink transmission timing.

In some other embodiments, the method further includes receiving third information about a first TA offset associated with the first TAG and a second TA offset associated to the second TAG.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 illustrates an example of multi-PDCCH based multi-TRP transmission with a single scheduler;

FIG. 2 illustrates an example of multi-PDCCH based multi-TRP transmission with independent schedulers;

FIG. 3 illustrates an example of PDSCH transmission with multi-DCI with multiple TRPs;

FIG. 4 illustrates an example of a single-PDCCH scheduling two different PDSCHs;

FIG. 5 illustrates an example of time alignment of uplink transmissions for a case (a) without timing advance and for a case (b) with timing advance;

FIG. 6 illustrates an example of MAC RAR;

FIG. 7 illustrates an example of Timing Advance Command MAC CE;

FIG. 8 is a schematic diagram of an example network architecture illustrating a communication system connected via an intermediate network to a host computer according to the principles in the present disclosure;

FIG. 9 is a block diagram of a host computer communicating via a network node with a wireless device over an at least partially wireless connection according to some embodiments of the present disclosure;

FIG. 10 is a flowchart illustrating example methods implemented in a communication system including a host computer, a network node and a wireless device for executing a client application at a wireless device according to some embodiments of the present disclosure;

FIG. 11 is a flowchart illustrating example methods implemented in a communication system including a host computer, a network node and a wireless device for receiving user data at a wireless device according to some embodiments of the present disclosure;

FIG. 12 is a flowchart illustrating example methods implemented in a communication system including a host computer, a network node and a wireless device for receiving user data from the wireless device at a host computer according to some embodiments of the present disclosure;

FIG. 13 is a flowchart illustrating example methods implemented in a communication system including a host computer, a network node and a wireless device for receiving user data at a host computer according to some embodiments of the present disclosure;

FIG. 14 is a flowchart of an example process in a network node according to some embodiments of the present disclosure;

FIG. 15 is a flowchart of an example process in a wireless device according to some embodiments of the present disclosure;

FIG. 16 is a flowchart of another example process in a network node according to some embodiments of the present disclosure;

FIG. 17 is a flowchart of another example process in a wireless device according to some embodiments of the present disclosure;

FIG. 18 illustrates an example of WD deriving TA offset between two TRPs based on DL RS associated to the two TRPs according to some embodiments of the present disclosure;

FIG. 19 illustrates an example of RRC configuration of two TAs for one serving cell according to some embodiments of the present disclosure;

FIG. 20 illustrates an example of RRC configuration of including a TA in a TCI state according to some embodiments of the present disclosure; and

FIG. 21 illustrates an example of MAC-CE carrying two TA offsets according to some embodiments of the present disclosure.

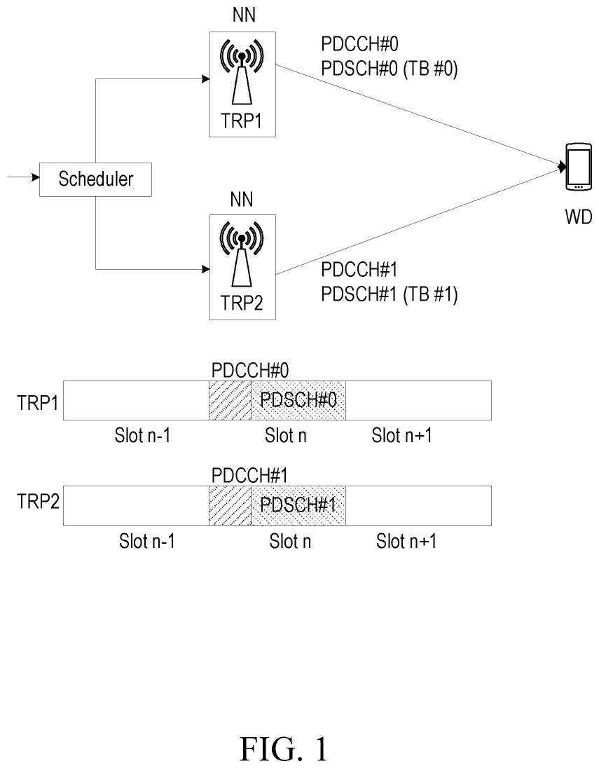

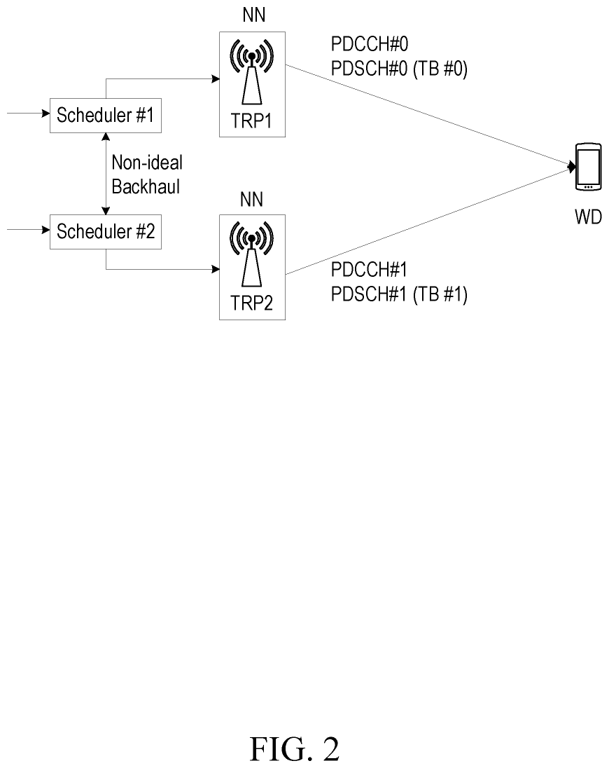

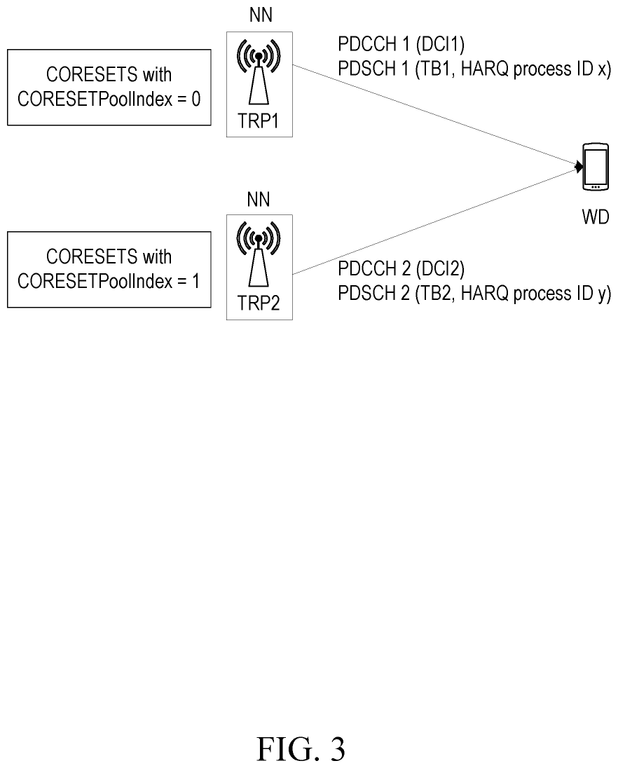

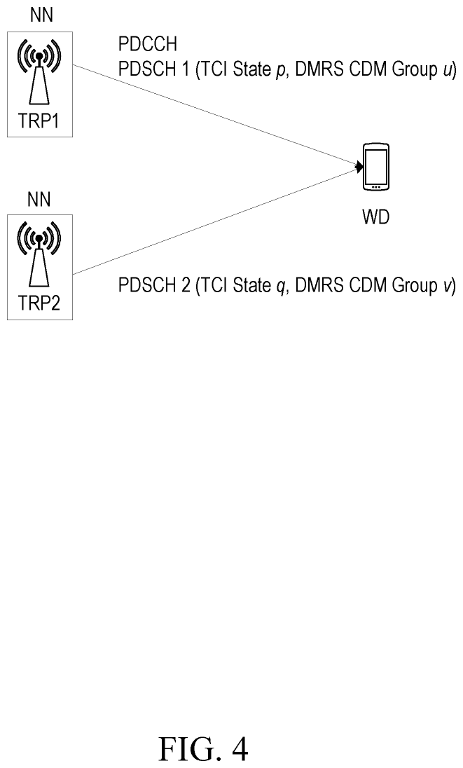

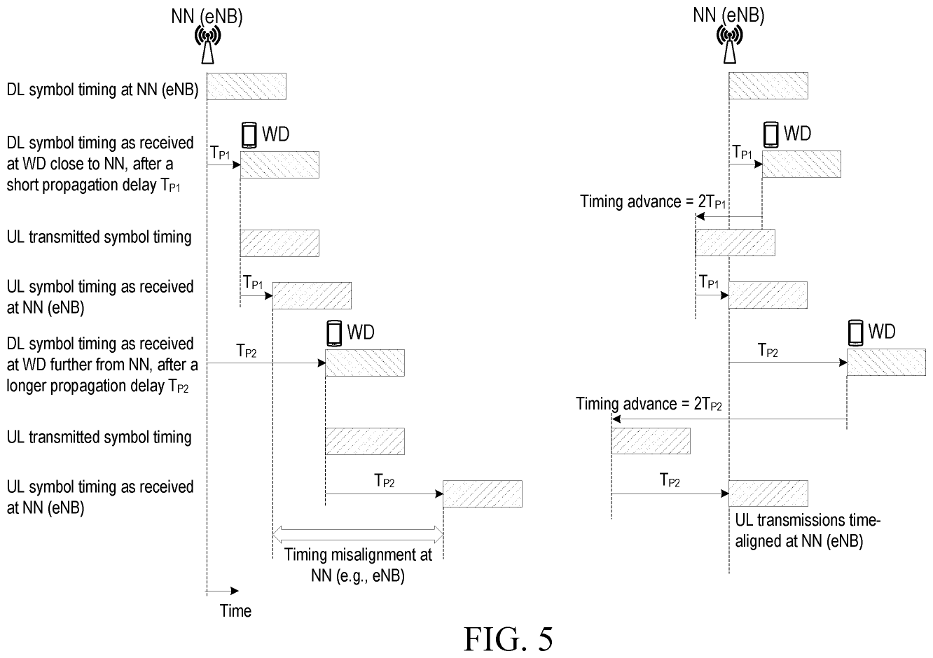

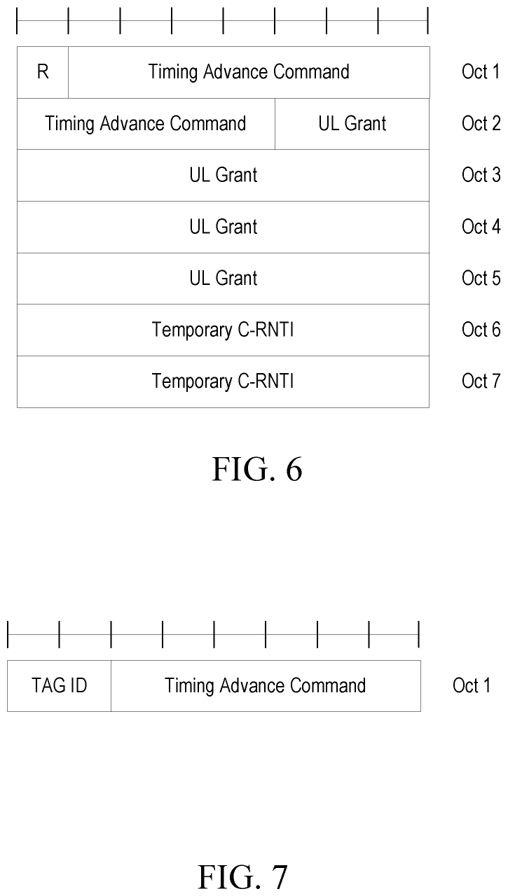

### DETAILED DESCRIPTION

In existing technology, the is timing (i.e., synchronization) between different TRPs may vary for different deployments. In addition, different TRPs may have different propagation delays to the WD which may impact the DL/UL timing even further.

For FR2, where the cyclic prefix (CP) length is much shorter than that for FR1, these DL/UL timing errors may be even more severe and may cause reduce performance during multi-TRP operation.

Hence, how to mitigate these issues associated with multi-TRP operation is an open problem in existing systems.

Some embodiments of the present disclosure provide a framework and signaling for enhancing timing advance for multi-DCI multi-TRP operation. One or more of the following aspects are included in the present disclosure:
Configuration of two TAs for the same serving cell;
Details of associating the two TAs with different TA reference timings;
Details of associating the two TAs with different TA offset indications; and/or
Details of maintaining different TA timers associated with the two TAs.

Some embodiments may provide or perform one or more of the following, which may be performed by a network node and/or a WD:
1. Configure the WD with two Time Advances (TAs) for the same serving cell, where the two TAs follow at least one of the following associations:
   a. the first TA is associated with a first TRP, and the second TA is associated with a second TRP;
   b. the first TA is associated with a first CORESETPoolIndex, and the second TA is associated with a second CORESETPoolIndex; and/or
   c. the first TA is associated with a first TCI state, and the second TA is associated with a second TCI state.
2. The first TA and the second TA are associated with different TA reference timings.
3. The WD uses a DL signal associated with a first TRP to determine the TA reference timing for the first TA, and the WD uses a DL signal associated with the second TRP to determine the TA reference timing for the second TA.
4. The WD uses a DL signal associated to a CORESET belonging to the first CORESETPoolIndex to determine the TA reference timing for the first TA, and the WD uses a DL signal associated to a CORESET belonging to the second CORESETPoolIndex to determine the TA reference timing for the second TA.
5. The WD uses a DL reference signal in the first TCI state to determine the TA reference timing for the first TA, and the WD uses a DL reference signal in the second TCI state to determine the TA reference timing for the second TA.
6. The DL reference signal (either the first DL reference signal or the second DL reference signal) to be used to determine the reference timing for the respective TA may be indicated by one of the following:
   a. The DL reference signal is indicated via a DCI that schedules any one of PUSCH, PUCCH, or SRS transmission.
   b. The DL reference signal is indicated via a DCI that activates a transmission in a preconfigured PUSCH resource (e.g., activating a PUSCH transmission for configured grant type II).
   c. The DL reference signal is indicated via a MAC CE that activates transmission in a preconfigured PUCCH resource or a preconfigured SRS resource.
7. The WD uses the first TA for any uplink transmission that uses the first TCI state, and the WD uses the second TA for any uplink transmission that uses the second TCI state.
8. The first TA and the second TA are associated with separate TA offset indications.
9. The WD receives a first TA offset for the first TA and a second TA offset for the second TA, where the first TA offset and the second TA offset are in the same MAC CE message.
10. The WD receives a first TA offset for the first TA and a second TA offset for the second TA, where the first TA offset and the second TA offset are in the separate MAC CE messages.
11. The first TA and the second TA are associated with different TA timers.
12. The WD resets or restarts a first TA timer associated with the first TA when receiving a first TA offset associated with the first TA.
13. The WD resets or restarts a second TA timer associated with the second TA when receiving a second TA offset associated with the second TA.
14. The second TA is determined by adding a TA offset to the first TA.
15. A TRP is represented by any one or more of:
   a. a TCI state;
   b. a CORESET or a CORESETPoolIndex;
   c. an SRS resource set;
   d. an SRI field in UL related DCI; and/or
   e. a TPMI field in UL related DCI.

Some embodiments advantageously provide arrangements for UL timing adjustment for WDs operating in multi-DCI multi-TRP operation.

Before describing in detail example embodiments, it is noted that the embodiments reside primarily in combinations of apparatus components and processing steps related to framework and signaling for multi-TA for mTRP. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”. “an” and “the” are intended to include the plural forms as well, unless the context clearly indicates otherwise. It will be further understood that the terms “comprises,” “comprising.” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate, and modifications and variations are possible of achieving the electrical and data communication.

In some embodiments described herein, the term “coupled.” “connected,” and the like, may be used herein to indicate a connection, although not necessarily directly. and may include wired and/or wireless connections.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), one or more TRPs, a scheduler, etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IoT) device, etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

Even though the descriptions herein may be explained in the context of one of a Downlink (DL) and an Uplink (UL) communication, it should be understood that the basic principles disclosed may also be applicable to the other of the one of the DL and the UL communication. In some embodiments in this disclosure, the principles may be considered applicable to a transmitter and a receiver. For DL communication, the network node is the transmitter, and the receiver is the WD. For the UL communication, the transmitter is the WD, and the receiver is the network node.

The terms “TRP”, “network node”, “base station” and “gNB” may be used interchangeably herein.

The term “signaling” used herein may comprise any of: high-layer signaling (e.g., via Radio Resource Control (RRC) or a like), lower-layer signaling (e.g., via a physical control channel or a broadcast channel), or a combination thereof. The signaling may be implicit or explicit. The signaling may further be unicast, multicast or broadcast. The signaling may also be directly to another node or via a third node.

The terms “radio measurement” and “timing measurement” used herein may refer to any measurement performed on radio signals. Radio measurements can be absolute or relative. Radio measurement may be called as signal level which may be signal quality and/or signal strength. Radio measurements can be e.g., intra-frequency, inter-frequency, inter-RAT measurements, CA measurements, etc. Radio measurements can be unidirectional (e.g., DL or UL) or bidirectional (e.g., Round Trip Time (RTT), Receive-Transmit (Rx-Tx), etc.). Some examples of radio measurements: timing measurements (e.g., Time of Arrival (TOA), timing advance, RTT, Reference Signal Time Difference (RSTD), Rx-Tx, propagation delay, etc.), angle measurements (e.g., angle of arrival), power-based measurements (e.g., received signal power, Reference Signals Received Power (RSRP), received signal quality, Reference Signals Received Quality (RSRQ), Signal-to-interference-plus-noise Ratio (SINR), Signal Noise Ratio (SNR), interference power, total interference plus noise, Received Signal Strength Indicator (RSSI), noise power, etc.), cell detection or cell identification, radio link monitoring (RLM), system information (SI) reading, etc.

Generally, it may be considered that the network, e.g., a signaling radio node and/or node arrangement (e.g., network node), configures a WD, in particular with the transmission resources. A resource may in general be configured with one or more messages. Different resources may be configured with different messages, and/or with messages on different layers or layer combinations. The size of a resource may be represented in symbols and/or subcarriers and/or resource elements and/or physical resource blocks (depending on domain), and/or in number of bits it may carry, e.g., information or payload bits, or total number of bits. The set of resources, and/or the resources of the sets, may pertain to the same carrier and/or bandwidth part, and/or may be located in the same slot, or in neighboring slots.

In some embodiments, control information on one or more resources may be considered to be transmitted in a message having a specific format. A message may comprise or represent bits representing payload information and coding bits, e.g., for error coding.

Receiving (or obtaining) control information may comprise receiving one or more control information messages (e.g., a parameter, index, etc.). It may be considered that receiving control signaling comprises demodulating and/or decoding and/or detecting, e.g., blind detection of, one or more messages, in particular a message carried by the control signaling, e.g., based on an assumed set of resources, which may be searched and/or listened for the control information. It may be assumed that both sides of the communication are aware of the configurations, and may determine the set of resources, e.g., based on the reference size.

Signaling may generally comprise one or more symbols and/or signals and/or messages. A signal may comprise or represent one or more bits. An indication may represent signaling, and/or be implemented as a signal, or as a plurality of signals. One or more signals may be included in and/or represented by a message. Signaling, in particular control signaling, may comprise a plurality of signals and/or messages, which may be transmitted on different carriers and/or be associated to different signaling processes, e.g., representing and/or pertaining to one or more such processes and/or corresponding information. An indication may comprise signaling, and/or a plurality of signals and/or messages and/or may be comprised therein, which may be transmitted on different carriers and/or be associated to different acknowledgement signaling processes, e.g., representing and/or pertaining to one or more such processes. Signaling associated to a channel may be transmitted such that represents signaling and/or information for that channel, and/or that the signaling is interpreted by the transmitter and/or receiver to belong to that channel. Such signaling may generally comply with transmission parameters and/or format/s for the channel.

An indication (e.g., an indication of an index, a parameter, a table, etc.) generally may explicitly and/or implicitly indicate the information it represents and/or indicates. Implicit indication may for example be based on position and/or resource used for transmission. Explicit indication may for example be based on a parametrization with one or more parameters, and/or one or more index or indices corresponding to a table, and/or one or more bit patterns representing the information.

A channel may generally be a logical, transport or physical channel. A channel may comprise and/or be arranged on one or more carriers, in particular a plurality of subcarriers. A channel carrying and/or for carrying control signaling/control information may be considered a control channel, in particular if it is a physical layer channel and/or if it carries control plane information. Analogously, a channel carrying and/or for carrying data signaling/user information may be considered a data channel, in particular if it is a physical layer channel and/or if it carries user plane information. A channel may be defined for a specific communication direction, or for two complementary communication directions (e.g., UL and DL, or sidelink in two directions), in which case it may be considered to have at least two component channels, one for each direction.

Transmitting in downlink may pertain to transmission from the network or network node to the terminal. The terminal may be considered the WD or UE. Transmitting in uplink may pertain to transmission from the terminal to the network or network node. Transmitting in sidelink may pertain to (direct) transmission from one terminal to another. Uplink, downlink and sidelink (e.g., sidelink transmission and reception) may be considered communication directions. In some variants, uplink and downlink may also be used to described wireless communication between network nodes, e.g., for wireless backhaul and/or relay communication and/or (wireless) network communication for example between base stations or similar network nodes, in particular communication terminating at such. It may be considered that backhaul and/or relay communication and/or network communication is implemented as a form of sidelink or uplink communication or similar thereto.

In some embodiments, the term TA information may refer to any information associated with timing advance, e.g., a TA value, a TA parameter, a TA index, a CORESET, a CORSESET pool, a CORSESET pool index.

### Configuring a Radio Node

Configuring a radio node, in particular a terminal or user equipment or the WD. may refer to the radio node being adapted or caused or set and/or instructed to operate according to the configuration. Configuring may be done by another device, e.g., a network node (for example, a radio node of the network like a base station or gNodeB) or network, in which case it may comprise transmitting configuration data to the radio node to be configured. Such configuration data may represent the configuration to be configured and/or comprise one or more instruction pertaining to a configuration, e.g., a configuration for transmitting and/or receiving on allocated resources, in particular frequency resources, or e.g., configuration for performing certain measurements on certain subframes or radio resources. A radio node may configure itself, e.g., based on configuration data received from a network or network node. A network node may use, and/or be adapted to use, its circuitry/ies for configuring. Allocation information may be considered a form of configuration data. Configuration data may comprise and/or be represented by configuration information, and/or one or more corresponding indications and/or message/s.

### Configuring in General

Generally, configuring may include determining configuration data representing the configuration and providing, e.g., transmitting, it to one or more other nodes (parallel and/or sequentially), which may transmit it further to the radio node (or another node, which may be repeated until it reaches the wireless device). Alternatively, or additionally, configuring a radio node, e.g., by a network node or other device, may include receiving configuration data and/or data pertaining to configuration data, e.g., from another node like a network node, which may be a higher-level node of the network, and/or transmitting received configuration data to the radio node. Accordingly, determining a configuration and transmitting the configuration data to the radio node may be performed by different network nodes or entities, which may be able to communicate via a suitable interface, e.g., an X2 interface in the case of LTE or a corresponding interface for NR. Configuring a terminal (e.g., WD) may comprise scheduling downlink and/or uplink transmissions for the terminal, e.g., downlink data and/or downlink control signaling and/or DCI and/or uplink control or data or communication signaling, in particular acknowledgement signaling, and/or configuring resources and/or a resource pool therefor. In particular, configuring a terminal (e.g., WD) may comprise configuring the WD to perform certain measurements on certain subframes or radio resources and reporting such measurements according to embodiments of the present disclosure.

A cell may be generally a communication cell, e.g., of a cellular or mobile communication network, provided by a node. A serving cell may be a cell on or via which a network node (the node providing or associated to the cell, e.g., base station or gNodeB) transmits and/or may transmit data (which may be data other than broadcast data) to a user equipment, in particular control and/or user or payload data, and/or via or on which a user equipment transmits and/or may transmit data to the node; a serving cell may be a cell for or on which the user equipment is configured and/or to which it is synchronized and/or has performed an access procedure, e.g., a random access procedure, and/or in relation to which it is in a RRC_connected or RRC_idle state, e.g., in case the node and/or user equipment and/or network follow the LTE and/or NR-standard. One or more carriers (e.g., uplink and/or downlink carrier/s and/or a carrier for both uplink and downlink) may be associated to a cell.

In some embodiments, the term “obtain” or “obtaining” is used herein and may indicate obtaining in e.g., memory such as in the case where the information is predefined or preconfigured or in the case where a network node or WD obtains the information from memory in order to transmit to another node/device. The term “obtain” or “obtaining” as used herein may also indicate obtaining by receiving signaling indicating the information obtained.

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices. Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments provide arrangements related to framework and signaling for multi-TA for mTRP.

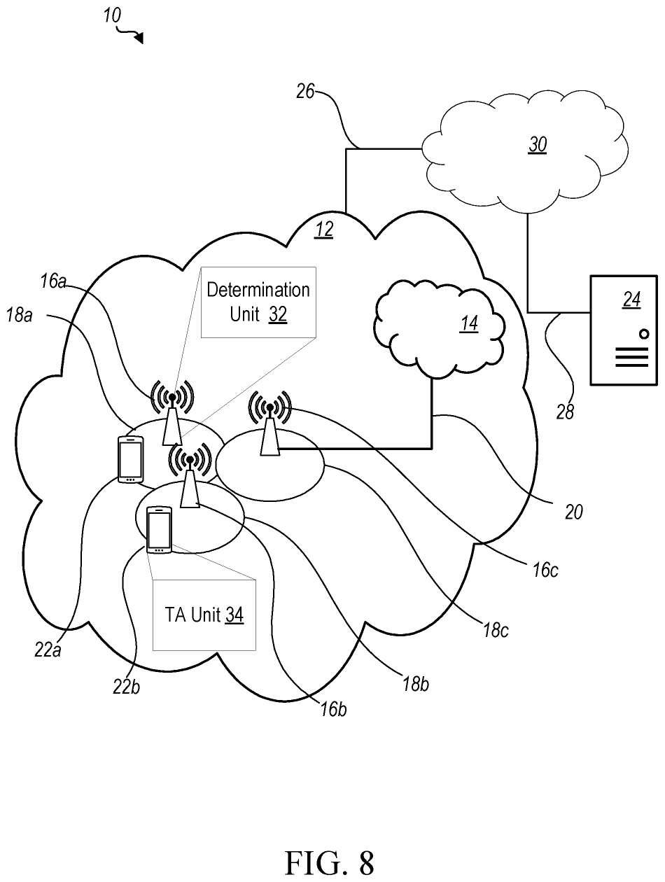

Referring again to the drawing figures, in which like elements are referred to by like reference numerals, there is shown in FIG. 8 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 8 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16 is configured to include a determination unit 32 which is configured to perform any step and/or task and/or process and/or method and/or feature described in the present disclosure, e.g., obtain at least one of a first timing advance (TA) information and a second TA information for the WD, the first and second TA information being for a same serving cell; and determine at least one of that the first TA information is associated with a first value of a first parameter and that the second TA information is associated with a second value of the first parameter. A wireless device 22 is configured to perform any step and/or task and/or process and/or method and/or feature described in the present disclosure, e.g., include a timing advance (TA) unit 34 which is configured to perform any step and/or task and/or process and/or method and/or feature described in the present disclosure, e.g., obtain a first timing advance (TA) information and a second TA information, the first and second TA information being for a same serving cell; and determine that the first TA information is associated with a first value of a first parameter and that the second TA information is associated with a second value of the first parameter.

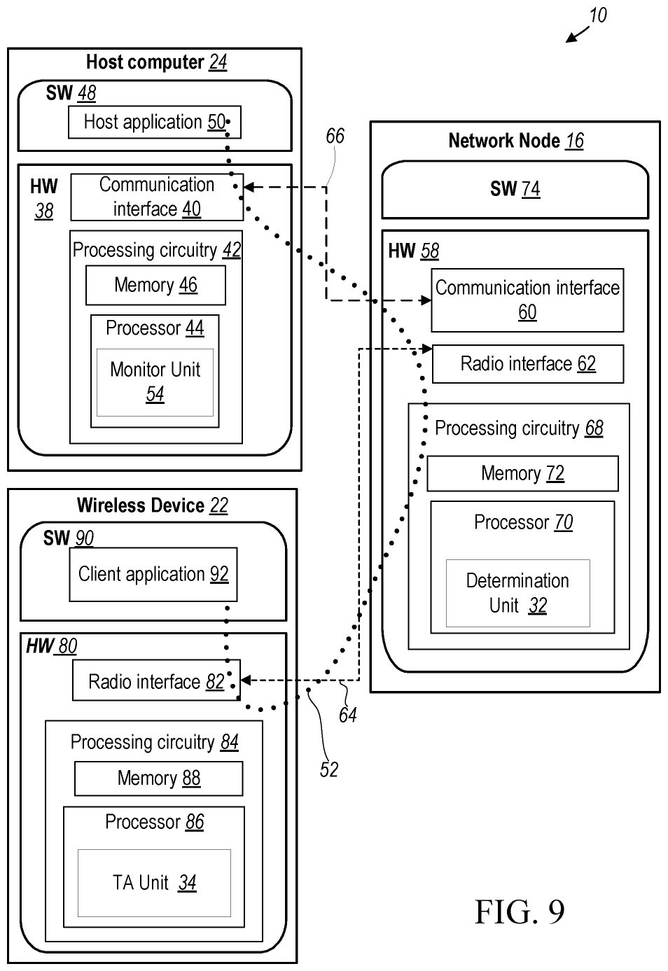

Example implementations, in accordance with an embodiment, of the WD 22, network node 16 and host computer 24 discussed in the preceding paragraphs will now be described with reference to FIG. 9. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and/or the wireless device 22. The processing circuitry 42 of the host computer 24 may include a monitor unit 54 configured to enable the service provider to observe, monitor, control, transmit to and/or receive from the network node 16 and/or the wireless device 22.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

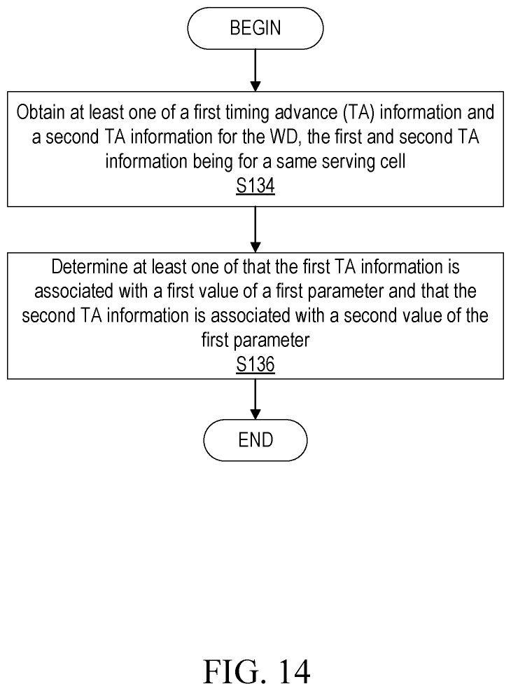

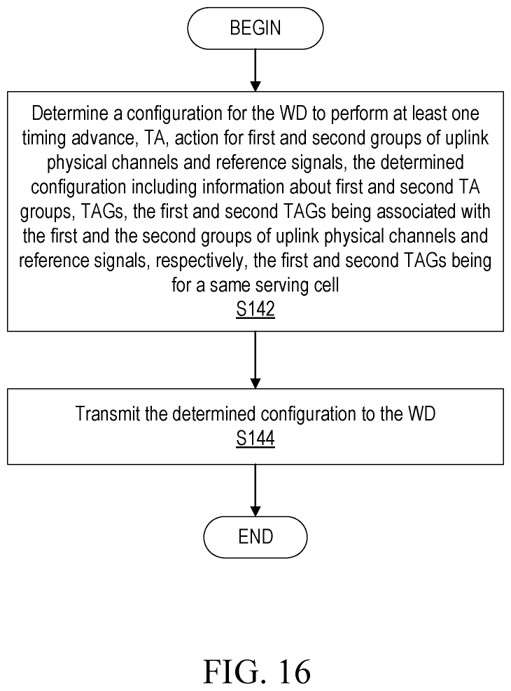

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include determination unit 32 configured to perform network node methods discussed herein, such as the methods discussed with reference to FIGS. 14 and 16 as well as other figures.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

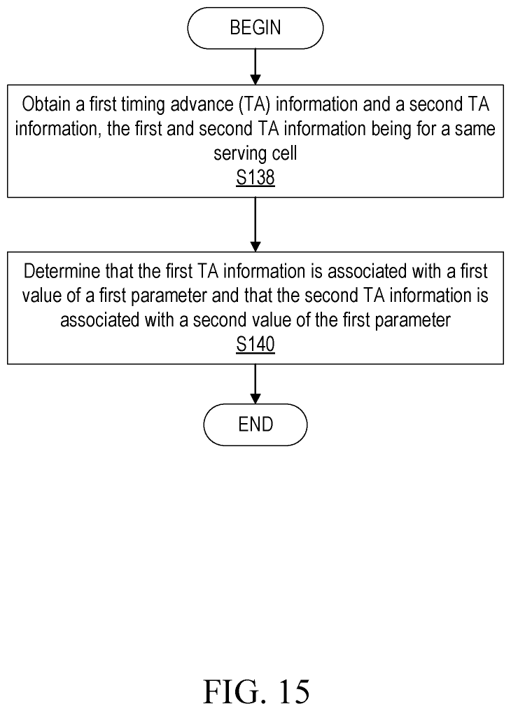

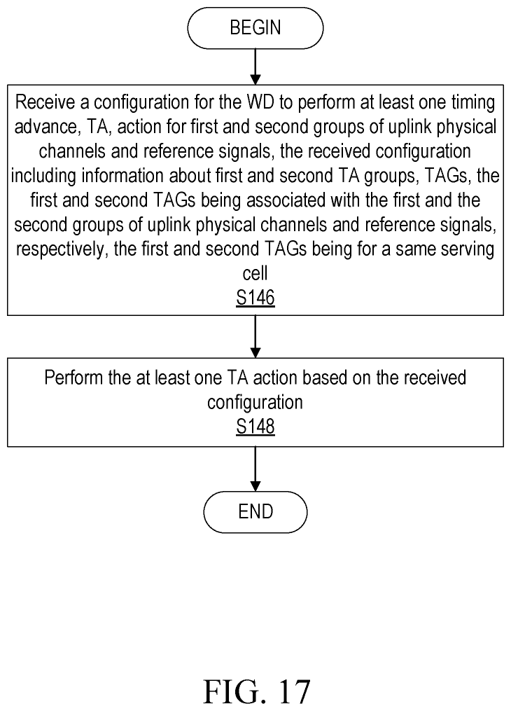

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22. For example, the processing circuitry 84 of the wireless device 22 may include a TA unit 34 configured to perform any step and/or task and/or process and/or method and/or feature described in the present disclosure, e.g., perform WD methods discussed herein, such as the methods discussed with reference to FIGS. 15 and 17 as well as other figures.

In some embodiments, the inner workings of the network node 16, WD 22, and host computer 24 may be as shown in FIG. 9 and independently, the surrounding network topology may be that of FIG. 8.

In FIG. 9, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 8 and 9 show various “units” such as determination unit 32, and TA unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

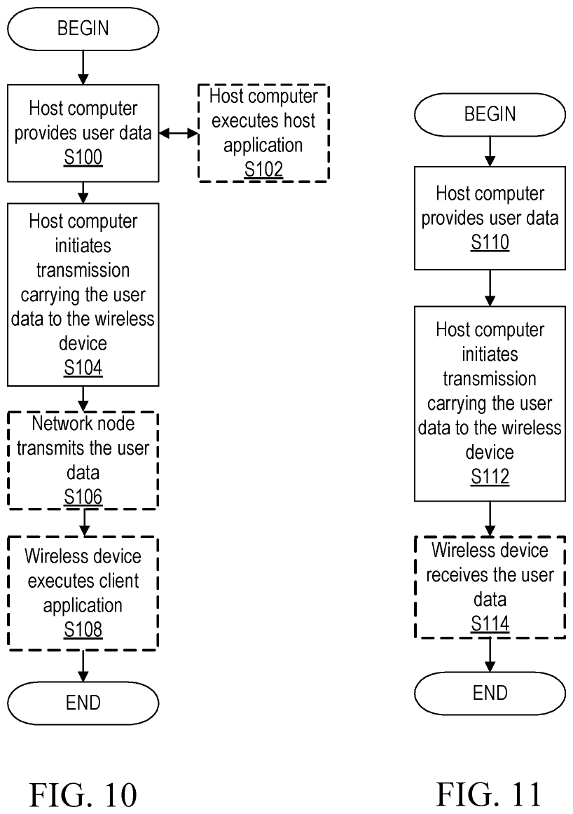

FIG. 10 is a flowchart illustrating an example method implemented in a communication system, such as, for example, the communication system of FIGS. 8 and 9, in accordance with one embodiment. The communication system may include a host computer 24, a network node 16 and a WD 22, which may be those described with reference to FIG. 9. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 11 is a flowchart illustrating an example method implemented in a communication system, such as, for example, the communication system of FIG. 8, in accordance with one embodiment. The communication system may include a host computer 24, a network node 16 and a WD 22, which may be those described with reference to FIGS. 8 and 9. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

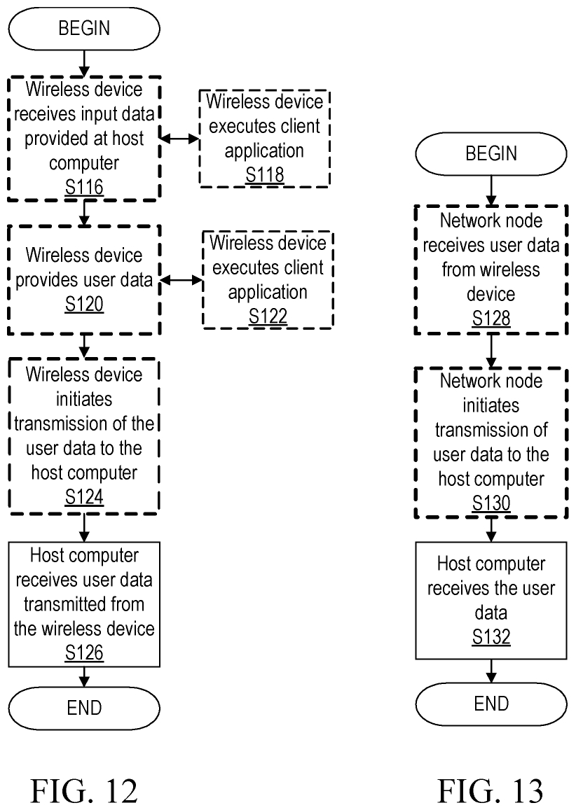

FIG. 12 is a flowchart illustrating an example method implemented in a communication system, such as, for example, the communication system of FIG. 8, in accordance with one embodiment. The communication system may include a host computer 24, a network node 16 and a WD 22, which may be those described with reference to FIGS. 8 and 9. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 13 is a flowchart illustrating an example method implemented in a communication system, such as, for example, the communication system of FIG. 8, in accordance with one embodiment. The communication system may include a host computer 24, a network node 16 and a WD 22, which may be those described with reference to FIGS. 8 and 9. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

FIG. 14 is a flowchart of an example process in a network node 16 according to some embodiments of the present disclosure. One or more Blocks and/or functions and/or methods performed by the network node 16 may be performed by one or more elements of network node 16 such as by determination unit 32 in processing circuitry 68, processor 70, radio interface 62, etc. according to the example method. Network node 16 such as by determination unit 32 in processing circuitry 68, processor 70 and/or radio interface 62, is configured to obtain (Block S134) at least one of a first timing advance (TA) information and a second TA information for the WD, the first and second TA information being for a same serving cell. Network node 16 such as by determination unit 32 in processing circuitry 68, processor 70 and/or radio interface 62, is configured to determine (Block S136) at least one of that the first TA information is associated with a first value of a first parameter and that the second TA information is associated with a second value of the first parameter.

In some embodiments, network node 16 such as by determination unit 32 in processing circuitry 68, processor 70 and/or radio interface 62, is configured to communicate and/or receive and/or adjust uplink (UL) timing in the same serving cell for the WD using at least one of the first TA information and the second TA information.

In some embodiments, one or more of:
the first and second TA information comprises a first and second TA command; the first value is different from the second value;
the first value is a same as the second value;
the first value is based on at least one of a propagation delay, a reference signal, and a timing measurement associated with a first network node/TRP and the second value is based on at least one of the propagation delay, the reference signal, and the timing measurement associated with a second network node/TRP;
the first and second values of the first parameter comprises at least one of: a first and second CORESET pool indices, a first and second bandwidth parts (BWPs), a first and second cyclic prefixes (CPs), a first and second TA reference timings, a first and second TA offset indications, a first and second TA timers, a first and second TCI states and a first and second timing advance group (TAG) identifiers (IDs); and
the association of the first and second values of the first parameter with the corresponding first and second TA information is at least one of: (i) configured via at least one a radio resource control (RRC) signaling and (ii) indicated in a medium access control (MAC) control element (CE).

In some embodiments, one or more of:
the first and second TAG IDs are both configured in a same serving cell configuration information element (IE);
the first and second TAG IDs are both configured in a same TAG configuration IE; and
the first and second TAG IDs are each associated with a corresponding TCI state.

FIG. 15 is a flowchart of an example process in a wireless device 22 according to some embodiments of the present disclosure. One or more Blocks and/or functions and/or methods performed by WD 22 may be performed by one or more elements of WD 22 such as by TA unit 34 in processing circuitry 84, processor 86, radio interface 82, etc. WD 22 such as by TA unit 34 in processing circuitry 84, processor 86 and/or radio interface 82, is configured to obtain (Block S138) a first timing advance (TA) information and a second TA information, the first and second TA information being for a same serving cell. WD 22 such as by TA unit 34 in processing circuitry 84, processor 86 and/or radio interface 82, is configured to determine (Block S140) that the first TA information is associated with a first value of a first parameter and that the second TA information is associated with a second value of the first parameter.

In some embodiments, WD 22 such as by TA unit 34 in processing circuitry 84, processor 86 and/or radio interface 82, is configured to communicate and/or transmit and/or adjust uplink (UL) timing in the same serving cell using both the first TA information and the second TA information.

In some embodiments, one or more of:
the first and second TA information comprises a first and second TA command;
the first value is different from the second value;
the first value is a same as the second value;
the first value is based on at least one of a propagation delay, a reference signal, and a timing measurement associated with a first network node/TRP and the second value is based on at least one of the propagation delay, the reference signal, and the timing measurement associated with a second network node/TRP;
the first and second values of the first parameter comprises at least one of: a first and second CORESET pool indices, a first and second bandwidth parts (BWPs), a first and second cyclic prefixes (CPs), a first and second TA reference timings, a first and second TA offset indications, a first and second TA timers, a first and second TCI states and a first and second timing advance group (TAG) identifiers (IDs); and
the association of the first and second values of the first parameter with the corresponding first and second TA information is at least one of: (i) configured via at least one a radio resource control (RRC) signaling and (ii) indicated in a medium access control (MAC) control element (CE).

In some embodiments, one or more of:
the first and second TAG IDs are both configured in a same serving cell configuration information element (IE);
the first and second TAG IDs are both configured in a same TAG configuration IE; and
the first and second TAG IDs are each associated with a corresponding TCI state.

FIG. 16 is a flowchart of an example process in a network node 16 according to some embodiments of the present disclosure. One or more Blocks and/or functions and/or methods performed by the network node 16 may be performed by one or more elements of network node 16 such as by determination unit 32 in processing circuitry 68, processor 70, radio interface 62, etc. according to the example method. Network node 16 such as by determination unit 32 in processing circuitry 68, processor 70 and/or radio interface 62, is configured to determine (Block S142) a configuration for the WD to perform at least one timing advance (TA) action for first and second groups of uplink physical channels and reference signals. The determined configuration includes information about first and second TA groups (TAGs). The first and second TAGs are associated with the first and the second groups of uplink physical channels and reference signals, respectively. The first and second TAGs are for a same serving cell. Further, network node 16 such as by determination unit 32 in processing circuitry 68, processor 70 and/or radio interface 62, is configured to transmit (Block S144) the determined configuration to the WD 22.

In some embodiments, the method further includes transmitting to the WD 22 at least one of a first TA command (TAC) associated to the first TAG; and a second TAC associated to the second TAG.

In some other embodiments, the first TAC includes first information about a first TA, and the second TAC includes second information about a second TA.

In an embodiment, the first and the second groups of uplink channels and reference signals are transmitted towards a first transmission reception point (TRP) and a second TRP, respectively.

In another embodiment, the first TAG and the second TAG are associated with at least one of a first TA reference timing and a second TA reference timing, respectively; a first TA offset indication and a second TA offset indication, respectively; and a first TA timer and a second TA timer, respectively.

In some embodiments, the first and the second TA offset indications are configured for the WD 22 by the network node 16.

In some other embodiments, the method further includes transmitting at least one of a first downlink reference signal from the first TRP; and a second downlink signal from the second TRP, where the first and second downlink signals is usable by the WD 22 to determine the first TA reference timing and the second TA reference timing, respectively.

In an embodiment, the determined configuration further includes at least a first control resource set (CORESET) with a first CORESET pool index and a second CORESET with a second CORESET pool index. The first CORESET pool index is associated with the first TAG, and the second CORESET pool index is associated with the second TAG.

In another embodiment, the method further includes transmitting signaling associated with at least one of the first and second CORESET pool indices. The transmitted signaling is usable by the WD 22 to determine the first TA reference timing for the first TAG associated with the first TRP and the second TA reference timing for the second TAG associated with the second TRP, respectively.

In some embodiments, the first and second groups of uplink physical channels and reference signals are associated with the first and second CORESET pool indices, respectively.

In some other embodiments, the determined configuration further comprises a list of transmission configuration indicator (TCI) states, where each TCI state of the list of TCI states is associated with one of the first and second TAGs.

In an embodiment, each one of the first and second groups of uplink physical channels and reference signals is associated with one TCI state of the list of TCI states.

In another embodiment, the method further includes transmitting a control element including at least one of a first TA indication and a second TA indication; at least one TAG identifier mapped to one of the first and second TA indications; a first bitfield indicating whether a TA offset is to be updated for at least one of a third TA and a fourth TA; and a second bitfield indicating which one of the third and fourth TAs is to be updated.

In some embodiments, performing the at least one TA action by the WD 22 includes adjusting uplink transmission timing for the first and second group of uplink channels and reference signals in the same serving cell based on the information about the first and the second TAGs, respectively; and transmitting the first and second group of uplink channels and reference signals using the adjusted uplink transmission timing.

In some other embodiments, the method further includes transmitting third information to the WD 22 about a first TA offset associated with the first TAG and a second TA offset associated to the second TAG.

FIG. 17 is a flowchart of an example process in a wireless device 22 according to some embodiments of the present disclosure. One or more Blocks and/or functions and/or methods performed by WD 22 may be performed by one or more elements of WD 22 such as by TA unit 34 in processing circuitry 84, processor 86, radio interface 82, etc. WD 22 such as by TA unit 34 in processing circuitry 84, processor 86 and/or radio interface 82, is configured to receive (Block S146) a configuration for the WD 22 to perform at least one timing advance (TA) action for first and second groups of uplink physical channels and reference signals. The received configuration includes information about first and second TA groups (TAGs). The first and second TAGs are associated with the first and the second groups of uplink physical channels and reference signals, respectively. The first and second TAGs are for a same serving cell. Further, WD 22 such as by TA unit 34 in processing circuitry 84, processor 86 and/or radio interface 82, is configured to perform the at least one TA action based on the received configuration.

In some embodiments, the method further includes receiving at least one of a first TA command (TAC) associated to the first TAG; and a second TAC associated to the second TAG.

In some other embodiments, the first TAC includes first information about a first TA, and the second TAC includes second information about a second TA.

In an embodiment, the first and the second groups of uplink channels and reference signals are transmitted towards a first transmission reception point (TRP) and a second TRP, respectively.

In another embodiment, the first TAG and the second TAG are associated with at least one of a first TA reference timing and a second TA reference timing, respectively; a first TA offset indication and a second TA offset indication, respectively; and a first TA timer and a second TA timer, respectively.

In some embodiments, the first and the second TA offset indications are configured for the WD 22 by the network node 16.

In some other embodiments, the method further includes receiving at least one of a first downlink reference signal from the first TRP; and a second downlink signal from the second TRP. The first and second downlink signals are usable by the WD 22 to determine the first TA reference timing and the second TA reference timing, respectively.

In an embodiment, the received configuration further includes at least a first control resource set (CORESET) with a first CORESET pool index and a second CORESET with a second CORESET pool index. The first CORESET pool index is associated with the first TAG, and the second CORESET pool index is associated with the second TAG.

In another embodiment, the method further includes receiving signaling associated with at least one of the first and second CORESET pool indices. The transmitted signaling is usable by the WD 22 to determine the first TA reference timing for the first TAG associated with the first TRP and the second TA reference timing for the second TAG associated with the second TRP, respectively.

In some embodiments, the first and second groups of uplink physical channels and reference signals are associated with the first and second CORESET pool indices, respectively.

In some other embodiments, the received configuration further comprises a list of transmission configuration indicator (TCI) states, where each TCI state of the list of TCI states is associated with one of the first and second TAGs.

In an embodiment, each one of the first and second groups of uplink physical channels and reference signals is associated with one TCI state of the list of TCI states.

In another embodiment, the method further includes receiving a control element including at least one of a first TA indication and a second TA indication; at least one TAG identifier mapped to one of the first and second TA indications; a first bitfield indicating whether a TA offset is to be updated for at least one of a third TA and a fourth TA; and a second bitfield indicating which one of the third and fourth TAs is to be updated.

In some embodiments, performing the at least one TA action by the WD 22 includes adjusting uplink transmission timing for the first and second group of uplink channels and reference signals in the same serving cell based on the information about the first and the second TAGs, respectively; and causing the radio interface to transmit the first and second group of uplink channels and reference signals using the adjusted uplink transmission timing.

In some other embodiments, the method further includes receiving third information about a first TA offset associated with the first TAG and a second TA offset associated to the second TAG.

Having described the general process flow of arrangements of the disclosure and having provided examples of hardware and software arrangements for implementing the processes and functions of the disclosure, the sections below provide details and examples of arrangements for framework and signaling for multi-TA for mTRP, which may be implemented by the network node 16, wireless device 22 and/or host computer 24.

In some embodiments, the term TRP used below may be interchanged with network node 16, e.g., first TRP may be interchanged with network node 16a and second TRP may be interchanged with network node 16b. In some other embodiments, a TRP may be either a network node, a radio head, a spatial relation, or a Transmission Configuration Indicator (TCI) state. A TRP may be represented by a TCI state in one or more embodiments. In some embodiments, a TRP may be using multiple TCI states.

In an embodiment, a TRP may be a part of the network node 16 (e.g., gNB) transmitting and receiving radio signals to/from a WD 22 (e.g., UE), according to physical layer properties and parameters inherent to that element. In some embodiments, a TRP may be a part of the network node 16 (e.g., gNB) transmitting and receiving radio signals to/from a WD 22 (e.g., UE) according to physical layer properties and parameters inherent to that element. In some embodiments, in Multiple Transmit/Receive Point (multi-TRP) operation, a serving cell can schedule a WD 22 (e.g., UE) from two TRPs, providing better PDSCH coverage (than typical systems), reliability and/or data rates. There may be two different operation modes for multi-TRP: single-DCI and multi-DCI. For both modes, control of uplink and downlink operation may be performed by both physical layer and MAC. In single-DCI mode, a WD 22 (e.g., UE) is scheduled by the same DCI for both TRPs. In multi-DCI mode, a WD 22 (e.g., UE) is scheduled by independent DCIs from each TRP. In some embodiments, a TRP may be represented by a SRS resource set, an SRI field in UL related DCI, or a TPMI field in UL related DCI.

### Embodiments

In an embodiment, the WD 22 is configured with multiple TAs for the same serving cell. In some embodiments, when the WD 22 is configured with two TAs of the same serving cell, the WD 22 may assume that one of the TAs is associated with a first TRP and a second TA is associated with a second TRP. For example, if the WD 22 is configured with two different CORESET Pool Indices of a serving cell, then the WD 22 can associate a first TA with a first CORESET Pool index and the second TA with a second CORESET Pool Index.

In one embodiment, the two TAs are associated with separate TA reference timings and/or separate TA offset indications and/or different TA timers.

In cases where the two TAs are associated with different TA reference timings, the WD 22 may use a DL signal associated with a first TRP to determine the TA reference timing for the TA associated with the first TRP. Further, the WD 22 may use a DL signal associated with the second TRP to determine the TA reference timing associated with the second TRP. For example, in case SSB1 to SSB4 is associated with a first TRP and SSB5 to SSB8 is associated with a second TRP (for example based on RRC configurations), then the WD 22 may use any of SSB1 to SSB4 (and/or another signal that is directly or indirectly QCL with any of SSB1 to SSB4) to determine the TA reference timing for the TA associated with the first TRP. The WD 22 may use any of SSB5 to SSB8 (and/or perhaps another signal that is directly or indirectly QCL with any of SSB5 to SSB8) to determine the TA reference timing for the TA associated with the second TRP.

In another example, where a first TRP is associated with a first CORESET Pool Index and a second TRP is associated with a second CORESET Pool Index, the WD 22 may use any signal directly or indirectly associated to a CORESET belonging to the first CORESET Pool Index to determine the TA reference timing for the TA associated with the first TRP. The WD 22 may use any signal directly or indirectly associated to a CORESET belonging to the second CORESET Pool Index to determine the TA reference timing for the TA associated with the second TRP.

In another embodiment, one TA is associated with a TCI state. Any UL transmission that utilizes the corresponding TCI state may apply (e.g., may be used by the WD 22 and/or network node 16 to apply) the associated TA. The DL RS in the TCI state may serve as timing reference. For example, if TCI state 10 contains SSB5 and tag_Id 2, any UL transmission that uses TCI state 10 may use (e.g., may be used by the WD 22 and/or network node 16 to apply) the TA corresponding to tag_Id 2 and SSB5 as timing reference.

In one embodiment, the two TAs (one per TRP) are associated with separate TA offset indications, and the network node 16 may indicate one TA offset for the TA associated with the first TRP (e.g., separately from the TA offset indicated for the TA associated with the second TRP). This could for example be performed by including two different TA offsets in the same MAC-CE or in different MAC CE messages.

In one embodiment, each TA is associated with its own TA timer. Every time a TA offset indication associated with one of the two TAs is received by the WD 22, the TA timer associated with that TA may be reset or restarted. In cases a WD 22 does not receive a TA offset indication for one of the TAs before the associated TA timer expires, the WD 22 may not be synchronized to the TRP associated with that TA.

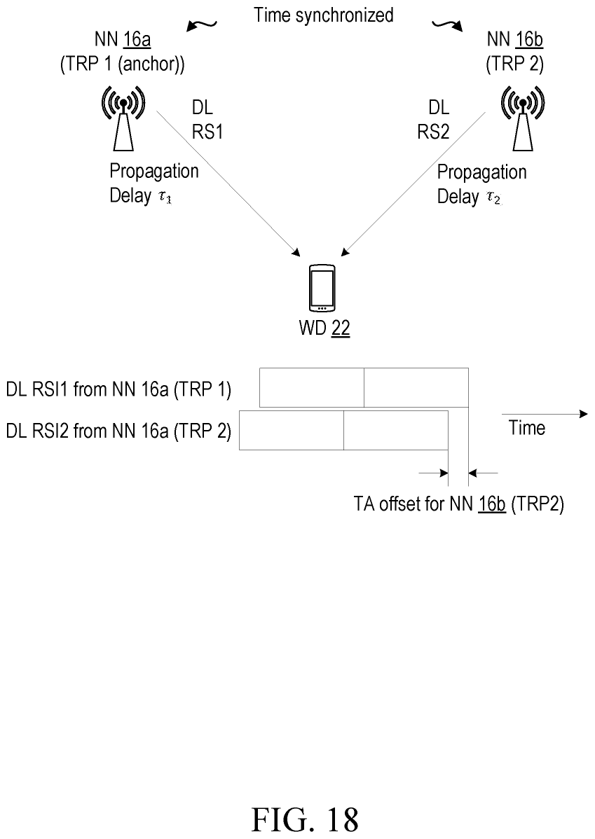

In another embodiment, when the timing is aligned at the multiple TRPs and the timing differences among the TRPs at the WD 22 are caused by different propagation delays, one TA may be configured and/or signaled to the WD 22. The TA may be associated with one of multiple TRPs, e.g., an anchor TRP to which a RACH was sent. For each of the remaining TRPs, the WD 22 may be configured to determine a TA offset based on a DL reference signal (e.g., SSB, TRS, periodic CSI-RS, etc.) associated with the TRP. The WD 22 applies the TA plus the TA offset (i.e., TA+TA offset) when sending UL signals to the TRP. An example is shown FIG. 18, where a first network node 16a (e.g., a TRP1) is an anchor TRP, and the TA is obtained and signaled. For TRP2, the WD 22 may be configured to determine a TA offset based on the DL time difference of the two DL reference signals (i.e., RS1 and RS2) observed at the WD 22.

In an embodiment, when a UL transmission to a network node 16 (e.g., TRP) is scheduled in a UL resource, the WD 22 may also be indicated explicitly or implicitly that a DL RS is used as the timing reference for an associated TA for the UL transmission. The DL RS may be a pathloss RS, a RS in a spatial relation associated with the UL resource, and/or a QCL source RS indicated in a TCI state.

In an embodiment, when a TA is signaled to the WD 22, a network node 16 (e.g., TRP) associated to the TA may also be indicated. The network node 16 (e.g., TRP) may be indicated by an associated CORESET pool index, a DL RS, a UL SRS resource or resource set index, a TCI state, or a spatial relation.

### Detailed Embodiments Related to RRC Configuration of TA

In one embodiment, the two TAs are associated to one serving cell by configuring an addition TAG ID in the ServingCellConfig IE, as described below. When the parameter (i.e., “tag-Id-New”) is configured, the WD 22 may implicitly assume that a first TA defined by the legacy TAG (“tag-Id”) is to be associated with a first TRP (for example a first CORESET Pool Index) and that a second TA defined by the TAG ID (tag-Id-New) is to be associated with a second TRP (for example a first CORESET Pool Index).

Example ServingCellConfig information element:

| -- ASN1START | |
|---|---|
| -- TAG-SERVINGCELLCONFIG-START | |
| ServingCellConfig ::= | SEQUENCE { |
| [...] | |
| tag-Id | TAG-Id, |

| | |
|---|---|
| tag-Id-New | TAG-Id |

[...]
}

In one embodiment, a TAG IE is introduced in TAG-Config IE, as described below in an example of RRC configuration of two TAs for one serving cell. When a serving cell is configured with a TAG ID that is associated with the TAG IE (i.e., “TAG-New”), the WD 22 may implicitly assume that a first TA with a timer defined by the new parameter timeAlignmentTime1 is to be associated with a first TRP (e.g., a first CORESET Pool Index) and that a second TA with a timer defined by the new parameter timeAlignmentTime2 is to be associated with a second TRP (e.g., a first CORESET Pool Index).

Example TAG-Config information element:

-- ASN1START
-- TAG-TAG-CONFIG-START

| | |
|---|---|
| TAG-Config ::= | SEQUENCE { |

[...]

| | |
|---|---|
| tag-ToAddModList | SEQUENCE (SIZE (1..maxNrofTAGs)) |

OF TAG
}

| | |
|---|---|
| TAG ::= | SEQUENCE { |
| tag-Id | TAG-Id, |

| | |
|---|---|
| timeAlignmentTimer | TimeAlignmentTimer, |

...
}

| | |
|---|---|
| TAG-New ::= | SEQUENCE { |

| | |
|---|---|
| tag-Id | TAG-Id, |

| | |
|---|---|
| timeAlignmentTimer1 | TimeAlignmentTimer, |
| timeAlignmentTimer2 | TimeAlignmentTimer, |

...

}

| | |
|---|---|
| TAG-Id ::= | INTEGER (0..maxNrofTAGs-1) |

| | |
|---|---|
| TimeAlignmentTimer ::= | ENUMERATED {ms500, ms750, |

ms1280, ms1920, ms2560, ms5120, ms10240, infinity}
-- TAG-TAG-CONFIG-STOP
-- ASN1STOP

In another embodiment, the TA is included in a TCI state. An example of such an extension of a TCI state is described below in an example RRC configuration of two TAs for one serving cell:

-- ASN1START
-- TAG-TCI-STATE-START

| TCI-State ::= | SEQUENCE { | |
|---|---|---|
| tci-StateId | TCI-StateId, | |
| qcl-Type1 | QCL-Info, | |
| qcl-Type2 | QCL-Info | |
| tag-Id | | TAG-ID |

...
}

| | |
|---|---|
| QCL-Info ::= | SEQUENCE { |
| cell | ServCellIndex |
| bwp-Id | BWP-Id |
| referenceSignal | CHOICE { |
| csi-rs | NZP-CSI-RS-ResourceId, |
| ssb | SSB-Index |

},

| | |
|---|---|
| qcl-Type | ENUMERATED {typeA, typeB, typeC, typeD}, |

...
}
-- TAG-TCI-STATE-STOP
-- ASN1STOP

### Detailed Embodiments Related to MAC-CE for Updating Multiple TAs

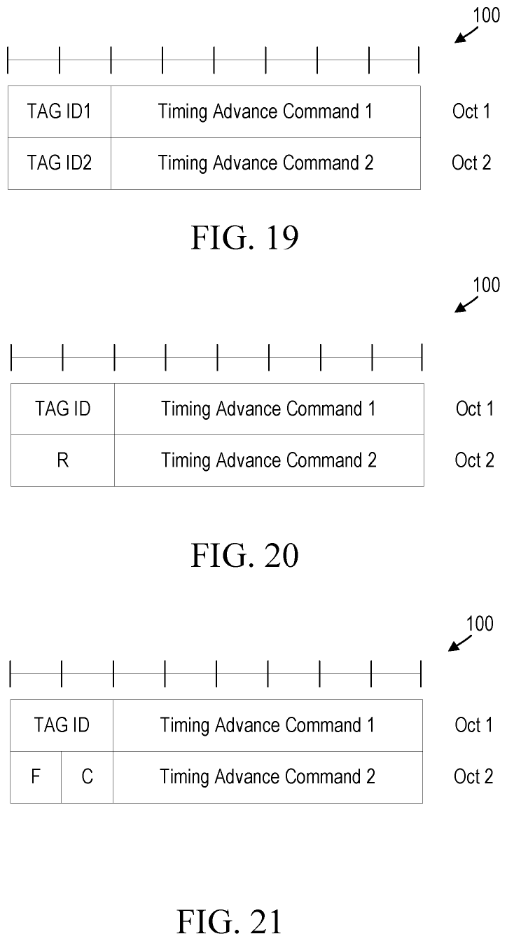

In one embodiment, a control element 100 (e.g., MAC-CE) is introduced which includes two (or more) TA offset indications and two TAG IDs, as shown in FIG. 19. In this example, the bitfield called “Timing Advance Command 1” is used to indicate the TA offset for the TA configured with TAG ID1, and the bitfield called “Timing Advance Command 2” is used to indicate the TA offset for the TA configured with TAG ID2. Although FIG. 19 illustrates an example of a control element 100 (e.g., MAC-CE) carrying two TA offsets, control element 100 is not limited as such and may include any one or more than two TA offsets/indications.

In one embodiment, as schematically illustrated in FIG. 20, where one TAG ID may be associated with two (or more) different TA, control element 100 (e.g., MAC-CE) may include two TA offset indications and one TAG ID. There may be an implicit mapping between the first TA offset indication (“Timing Advance Command 1”) and the TA associated with a first TRP, and an implicit mapping between the second TA offset indication (“Timing Advance Command 2”) and the TA associated with the second TRP. The remaining two bits of the second OCTet can be reserved. Although FIG. 20 illustrates an example of control element 100 (e.g., MAC-CE) carrying two TA offsets, control element 100 is not limited as such and may include any one or more than two TA offsets/indications.

In another embodiment, as shown in FIG. 21, where one TAG ID may be associated with two different TA, control element 100 (e.g., MAC-CE) may include two (or more) TA offset indications and one TAG ID. In this case, there is an implicit mapping between the first TA offset indication (“Timing Advance Command 1”) and the TA associated with a first TRP, and an implicit mapping between the second TA offset indication (“Timing Advance Command 2”) and the TA associated with the second TRP. In addition, two remaining bits may be used to indicate if both TAs should be updated (or only one of them). Which of the two TAs that should be updated may also be indicated. For example, a single bitfield “F” can be used to indicate if the TA offset should be update for both TAs, or only for one of the TAs. For example, if F=0, both TAs should be updated, and if F=1, then only one of the TAs should be updated. In case only one of the TAs should be updated, then the single bitfield “C” may be used to indicate if the TA associated with a first TRP should be updated, or if the TA associated with a second TRP should be updated (e.g., the single bitfield “C” includes the CORESET Pool Index). In another example of this embodiment, the two bitfields “F” and “C” may be combined to one bitfield and where each codepoint of the two-bit bitfield can indicate if one or both TAs should be updated and if only one is updated, which of the TAs. In case only one TA is updated, the WD 22 may be configured to ignore the second bitfield “Timing Advance Command 2”, and to use the TA offset indicated in “Timing Advance Command 1” to update either the TA associated with a first TRP or the TA associated with a second TRP (depending on the value in “C”). In some other embodiments, only one of the TAs is updated, for example if one of the TRPs have not received any UL signals for a predetermined interval of time, and hence does not know how to adjust the associated TA (or want to reset the TA timer that is associated with that TRP). Although FIG. 21 shows an example of control element 100 (e.g., MAC-CE) carrying two TA offsets, control element 100 is not limited as such and may include any one or more than two TA offsets/indications.

### Detailed Embodiments Related to UL Timing Re-Establishments for Multiple TAs

In one embodiment, when the WD 22 is no longer synchronized with one of the two TRPs, the network node 16 can trigger the WD 22 to transmit a PRACH towards the TRP that is not synchronized, in order to re-establish the synchronization to that TRP.

In one other embodiment, the network node (NN) 16 (e.g., gNB) can trigger the WD 22 to transmit a PRACH with a spatial filter that is associated (directly or indirectly) with one of the SSBs transmitted from that TRP.

In some embodiments, the network node 16 may be configured to trigger the WD 22 to transmit a PRACH with a spatial filter that is associated with one of the CORESETs belonging to the CORESET Pool Index associated with that TRP. For example may be where CORESET 0 is configured with CORESET Pool Index 0 and is associated to TRP1, and the WD 22 has lost synchronization to this TRP (TRP1). In this example, network node 16 may be configured to trigger the WD 22 to transmit a PRACH in a spatial filter associated with the DL/UL/Joint TCI state associated with CORESET 0.

In one more embodiments, NN 16 may trigger (via the synchronized TRP) an SRS transmission to the out of sync TRP from the WD 22 and derive a TA based on the received SRS at the out of sync TRP. The TA can be sent to the WD 22 via the synchronized TRP to be applied to signals transmitted to the out of sync TRP.

The following is a nonlimiting list of example embodiments:

Embodiment A1. A network node configured to communicate with a wireless device (WD), the network node configured to, and/or comprising a radio interface and/or comprising processing circuitry configured to:
obtain at least one of a first timing advance (TA) information and a second TA information for the WD, the first and second TA information being for a same serving cell; and
determine at least one of that the first TA information is associated with a first value of a first parameter and that the second TA information is associated with a second value of the first parameter.

Embodiment A2. The network node of Embodiment A1, wherein the network node and/or the radio interface and/or the processing circuitry being further configured to:
communicate and/or receive and/or adjust uplink (UL) timing in the same serving cell for the WD using at least one of the first TA information and the second TA information.

Embodiment A3. The network node of any one of Embodiments A1 and A2, wherein one or more of:
the first and second TA information comprises a first and second TA command;
the first value is different from the second value;
the first value is a same as the second value;
the first value is based on at least one of a propagation delay, a reference signal, and a timing measurement associated with a first network node/TRP and the second value is based on at least one of the propagation delay, the reference signal, and the timing measurement associated with a second network node/TRP;
the first and second values of the first parameter comprises at least one of: a first and second CORESET pool indices, a first and second bandwidth parts (BWPs), a first and second cyclic prefixes (CPs), a first and second TA reference timings, a first and second TA offset indications, a first and second TA timers, a first and second TCI states and a first and second timing advance group (TAG) identifiers (IDs); and
the association of the first and second values of the first parameter with the corresponding first and second TA information is at least one of: (i) configured via at least one a radio resource control (RRC) signaling and (ii) indicated in a medium access control (MAC) control element (CE).

Embodiment A4. The network node of Embodiment A3, wherein one or more of:
the first and second TAG IDs are both configured in a same serving cell configuration information element (IE);
the first and second TAG IDs are both configured in a same TAG configuration IE; and
the first and second TAG IDs are each associated with a corresponding TCI state.

Embodiment B1. A method implemented in a network node, the method comprising:
obtaining at least one of a first timing advance (TA) information and a second TA information for the WD, the first and second TA information being for a same serving cell; and
determine at least one of that the first TA information is associated with a first value of a first parameter and that the second TA information is associated with a second value of the first parameter.

Embodiment B2. The method of Embodiment B1, further comprising:
communicating and/or receiving and/or adjusting uplink (UL) timing in the same serving cell for the WD using at least one of the first TA information and the second TA information.

Embodiment B3. The method of any one of Embodiments B1 and B2, wherein one or more of:
the first and second TA information comprises a first and second TA command;
the first value is different from the second value;
the first value is a same as the second value;
the first value is based on at least one of a propagation delay, a reference signal, and a timing measurement associated with a first network node/TRP and the second value is based on at least one of the propagation delay, the reference signal, and the timing measurement associated with a second network node/TRP;
the first and second values of the first parameter comprises at least one of: a first and second CORESET pool indices, a first and second bandwidth parts (BWPs), a first and second cyclic prefixes (CPs), a first and second TA reference timings, a first and second TA offset indications, a first and second TA timers, a first and second TCI states and a first and second timing advance group (TAG) identifiers (IDs); and
the association of the first and second values of the first parameter with the corresponding first and second TA information is at least one of: (i) configured via at least one a radio resource control (RRC) signaling and (ii) indicated in a medium access control (MAC) control element (CE).

Embodiment B4. The method of Embodiment B3, wherein one or more of:
the first and second TAG IDs are both configured in a same serving cell configuration information element (IE);
the first and second TAG IDs are both configured in a same TAG configuration IE; and
the first and second TAG IDs are each associated with a corresponding TCI state.

Embodiment C1. A wireless device (WD) configured to communicate with a network node, the WD configured to, and/or comprising a radio interface and/or processing circuitry configured to:
obtain a first timing advance (TA) information and a second TA information, the first and second TA information being for a same serving cell; and
determine that the first TA information is associated with a first value of a first parameter and that the second TA information is associated with a second value of the first parameter.

Embodiment C2. The WD of Embodiment C1, wherein the WD and/or the radio interface and/or the processing circuitry being further configured to:
communicate and/or transmit and/or adjust uplink (UL) timing in the same serving cell using both the first TA information and the second TA information.

Embodiment C3. The WD of any one of Embodiments C1 and C2, wherein one or more of:
the first and second TA information comprises a first and second TA command;
the first value is different from the second value;
the first value is a same as the second value;
the first value is based on at least one of a propagation delay, a reference signal, and a timing measurement associated with a first network node/TRP and the second value is based on at least one of the propagation delay, the reference signal, and the timing measurement associated with a second network node/TRP;
the first and second values of the first parameter comprises at least one of: a first and second CORESET pool indices, a first and second bandwidth parts (BWPs), a first and second cyclic prefixes (CPs), a first and second TA reference timings, a first and second TA offset indications, a first and second TA timers, a first and second TCI states and a first and second timing advance group (TAG) identifiers (IDs); and
the association of the first and second values of the first parameter with the corresponding first and second TA information is at least one of: (i) configured via at least one a radio resource control (RRC) signaling and (ii) indicated in a medium access control (MAC) control element (CE).

Embodiment C4. The WD of Embodiment C3, wherein one or more of:
the first and second TAG IDs are both configured in a same serving cell configuration information element (IE);
the first and second TAG IDs are both configured in a same TAG configuration IE; and
the first and second TAG IDs are each associated with a corresponding TCI state.

Embodiment D1. A method implemented in a wireless device (WD), the method comprising:
obtaining a first timing advance (TA) information and a second TA information, the first and second TA information being for a same serving cell; and
determining that the first TA information is associated with a first value of a first parameter and that the second TA information is associated with a second value of the first parameter.

Embodiment D2. The method of Embodiment D1, further comprising:
communicating and/or transmitting and/or adjusting uplink (UL) timing in the same serving cell using both the first TA information and the second TA information.

Embodiment D3. The method of any one of Embodiments D1 and D2, wherein one or more of:
the first and second TA information comprises a first and second TA command;
the first value is different from the second value;
the first value is a same as the second value;
the first value is based on at least one of a propagation delay, a reference signal, and a timing measurement associated with a first network node/TRP and the second value is based on at least one of the propagation delay, the reference signal, and the timing measurement associated with a second network node/TRP;
the first and second values of the first parameter comprises at least one of: a first and second CORESET pool indices, a first and second bandwidth parts (BWPs), a first and second cyclic prefixes (CPs), a first and second TA reference timings, a first and second TA offset indications, a first and second TA timers, a first and second TCI states and a first and second timing advance group (TAG) identifiers (IDs); and
the association of the first and second values of the first parameter with the corresponding first and second TA information is at least one of: (i) configured via at least one a radio resource control (RRC) signaling and (ii) indicated in a medium access control (MAC) control element (CE).

Embodiment D4. The method of Embodiment D3, wherein one or more of:
the first and second TAG IDs are both configured in a same serving cell configuration information element (IE);
the first and second TAG IDs are both configured in a same TAG configuration IE; and
the first and second TAG IDs are each associated with a corresponding TCI state.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object-oriented programming language such as Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

What is claimed is:

1. A network node (16) configured to communicate with a wireless device, WD (22), the network node (16) comprising:
processing circuitry (68) configured to:
determine a configuration for the WD (22) to perform at least one timing advance, TA, action for first and second groups of uplink physical channels and reference signals, the determined configuration including information about first and second TA groups, TAGs, the first and second TAGs being associated with the first and the second groups of uplink physical channels and reference signals, respectively, the first and second TAGs being for a same serving cell; and
a radio interface (62) in communication with the processing circuitry (68), the radio interface (62) being configured to:
transmit the determined configuration to the WD (22).

2. The network node (16) of claim 1, wherein the radio interface (62) is further configured to:
transmit to the WD (22) at least one of:
a first TA command, TAC, associated to the first TAG; and
a second TAC associated to the second TAG.

3. The network node (16) of claim 2, wherein the first TAC includes first information about a first TA, and the second TAC includes second information about a second TA.

4. The network node (16) of any one of claims 2 and 3, wherein the first and the second groups of uplink channels and reference signals are transmitted towards a first transmission reception point, TRP, and a second TRP, respectively.

5. The network node (16) of claim 4, wherein the first TAG and the second TAG are associated with at least one of:
a first TA reference timing and a second TA reference timing, respectively;
a first TA offset indication and a second TA offset indication, respectively; and
a first TA timer and a second TA timer, respectively.

6. The network node (16) of claim 5, wherein the first and the second TA offset indications are configured for the WD (22) by the network node (16).

7. The network node (16) of any one of claims 5 and 6, wherein the radio interface (62) is further configured to transmit at least one of:
a first downlink reference signal from the first TRP; and
a second downlink signal from the second TRP, the first and second downlink signals being usable by the WD (22) to determine the first TA reference timing and the second TA reference timing, respectively.

8. The network node (16) of any one of claims 5-7, wherein the determined configuration further includes at least a first control resource set, CORESET, with a first CORESET pool index and a second CORESET with a second CORESET pool index, the first CORESET pool index being associated with the first TAG, the second CORESET pool index being associated with the second TAG.

9. The network node (16) of claim 8, wherein the radio interface (62) is further configured to:
transmit signaling associated with at least one of the first and second CORESET pool indices, the transmitted signaling being usable by the WD (22) to determine the first TA reference timing for the first TAG associated with the first TRP and the second TA reference timing for the second TAG associated with the second TRP, respectively.

10. The network node (16) of any one of claims 8 and 9, wherein the first and second groups of uplink physical channels and reference signals are associated with the first and second CORESET pool indices, respectively.

11. The network node of any one of claims 1-10, wherein the determined configuration further comprises a list of transmission configuration indicator, TCI, states, and each TCI state of the list of TCI states is associated with one of the first and second TAGs.

12. The network node (16) of claim 11, wherein each one of the first and second groups of uplink physical channels and reference signals is associated with one TCI state of the list of TCI states.

13. The network node (16) of any of claims 1-12, wherein the radio interface (62) is further configured to:
transmit a control element including at least one of:
a first TA indication and a second TA indication;
at least one TAG identifier mapped to one of the first and second TA indications;
a first bitfield indicating whether a TA offset is to be updated for at least one of a third TA and a fourth TA; and
a second bitfield indicating which one of the third and fourth TAs is to be updated.

14. The network node (16) of any one of claims 1-13, wherein performing the at least one TA action by the WD (22) includes:
adjusting uplink transmission timing for the first and second group of uplink channels and reference signals in the same serving cell based on the information about the first and the second TAGs, respectively; and
transmitting the first and second group of uplink channels and reference signals using the adjusted uplink transmission timing.

15. The network node (16) of any one of claims 1-14, wherein the radio interface (62) is further configured to:
transmit third information to the WD (22) about a first TA offset associated with the first TAG and a second TA offset associated to the second TAG.

16. A method in a network node (16) configured to communicate with a wireless device, WD (22), the method comprising:
determining (S142) a configuration for the WD (22) to perform at least one timing advance, TA, action for first and second groups of uplink physical channels and reference signals, the determined configuration including information about first and second TA groups, TAGs, the first and second TAGs being associated with the first and the second groups of uplink physical channels and reference signals, respectively, the first and second TAGs being for a same serving cell; and
transmitting (S144) the determined configuration to the WD (22).

17. The method of claim 16, wherein the method further includes:
transmitting to the WD (22) at least one of:
a first TA command, TAC, associated to the first TAG; and
a second TAC associated to the second TAG.

18. The method of claim 17, wherein the first TAC includes first information about a first TA, and the second TAC includes second information about a second TA.

19. The method of any one of claims 17 and 18, wherein the first and the second groups of uplink channels and reference signals are transmitted towards a first transmission reception point, TRP, and a second TRP, respectively.

20. The method of claim 19, wherein the first TAG and the second TAG are associated with at least one of:
a first TA reference timing and a second TA reference timing, respectively;
a first TA offset indication and a second TA offset indication, respectively; and
a first TA timer and a second TA timer, respectively.

21. The method of claim 20, wherein the first and the second TA offset indications are configured for the WD (22) by the network node (16).

22. The method of any one of claims 20 and 21, wherein the method further includes transmitting at least one of:
a first downlink reference signal from the first TRP; and
a second downlink signal from the second TRP, the first and second downlink signals being usable by the WD (22) to determine the first TA reference timing and the second TA reference timing, respectively.

23. The method of any one of claims 20-22, wherein the determined configuration further includes at least a first control resource set, CORESET, with a first CORESET pool index and a second CORESET with a second CORESET pool index, the first CORESET pool index being associated with the first TAG, the second CORESET pool index being associated with the second TAG.

24. The method of claim 23, wherein the method further includes:
transmitting signaling associated with at least one of the first and second CORESET pool indices, the transmitted signaling being usable by the WD (22) to determine the first TA reference timing for the first TAG associated with the first TRP and the second TA reference timing for the second TAG associated with the second TRP, respectively.

25. The method of any one of claims 23 and 24, wherein the first and second groups of uplink physical channels and reference signals are associated with the first and second CORESET pool indices, respectively.

26. The method of any one of claims 16-25, wherein the determined configuration further comprises a list of transmission configuration indicator, TCI, states, and each TCI state of the list of TCI states is associated with one of the first and second TAGs.

27. The method of claim 26, wherein each one of the first and second groups of uplink physical channels and reference signals is associated with one TCI state of the list of TCI states.

28. The method of any of claims 16-27, wherein the method further includes:
transmitting a control element including at least one of:
a first TA indication and a second TA indication;
at least one TAG identifier mapped to one of the first and second TA indications;
a first bitfield indicating whether a TA offset is to be updated for at least one of a third TA and a fourth TA; and
a second bitfield indicating which one of the third and fourth TAs is to be updated.

29. The method of any one of claims 16-28, wherein performing the at least one TA action by the WD (22) includes:
adjusting uplink transmission timing for the first and second group of uplink channels and reference signals in the same serving cell based on the information about the first and the second TAGs, respectively; and
transmitting the first and second group of uplink channels and reference signals using the adjusted uplink transmission timing.

30. The method of any one of claims 16-29, wherein the method further includes:
transmitting third information to the WD (22) about a first TA offset associated with the first TAG and a second TA offset associated to the second TAG.

31. A wireless device, WD (22), configured to communicate with a network node (16), the WD (22) comprising:
a radio interface (82) configured to:
receive a configuration for the WD (22) to perform at least one timing advance, TA, action for first and second groups of uplink physical channels and reference signals, the received configuration including information about first and second TA groups, TAGs, the first and second TAGs being associated with the first and the second groups of uplink physical channels and reference signals, respectively, the first and second TAGs being for a same serving cell; and
processing circuitry (84) in communication with the radio interface (82), the processing circuitry (84) being configured to:
perform the at least one TA action based on the received configuration.

32. The WD (22) of claim 31, wherein the radio interface (82) is further configured to:
receive at least one of:
a first TA command, TAC, associated to the first TAG; and
a second TAC associated to the second TAG.

33. The WD (22) of claim 32, wherein the first TAC includes first information about a first TA, and the second TAC includes second information about a second TA.

34. The WD (22) of any one of claims 32 and 33, wherein the first and the second groups of uplink channels and reference signals are transmitted towards a first transmission reception point, TRP, and a second TRP, respectively.

35. The WD (22) of claim 34, wherein the first TAG and the second TAG are associated with at least one of:
a first TA reference timing and a second TA reference timing, respectively;
a first TA offset indication and a second TA offset indication, respectively; and
a first TA timer and a second TA timer, respectively.

36. The WD (22) of claim 35, wherein the first and the second TA offset indications are configured for the WD (22) by the network node (16).

37. The WD (22) of any one of claims 35 and 36, wherein the radio interface (82) is further configured to receive at least one of:
a first downlink reference signal from the first TRP; and
a second downlink signal from the second TRP, the first and second downlink signals being usable by the WD (22) to determine the first TA reference timing and the second TA reference timing, respectively.

38. The WD (22) of any one of claims 35-37, wherein the received configuration further includes at least a first control resource set, CORESET, with a first CORESET pool index and a second CORESET with a second CORESET pool index, the first CORESET pool index being associated with the first TAG, the second CORESET pool index being associated with the second TAG.

39. The WD (22) of claim 38, wherein the radio interface (82) is further configured to:
receive signaling associated with at least one of the first and second CORESET pool indices, the transmitted signaling being usable by the WD (22) to determine the first TA reference timing for the first TAG associated with the first TRP and the second TA reference timing for the second TAG associated with the second TRP, respectively.

40. The WD (22) of any one of claims 38 and 39, wherein the first and second groups of uplink physical channels and reference signals are associated with the first and second CORESET pool indices, respectively.

41. The WD (22) of any one of claims 31-40, wherein the received configuration further comprises a list of transmission configuration indicator, TCI, states, and each TCI state of the list of TCI states is associated with one of the first and second TAGs.

42. The WD (22) of claim 41, wherein each one of the first and second groups of uplink physical channels and reference signals is associated with one TCI state of the list of TCI states.

43. The WD (22) of any of claims 31-42, wherein the radio interface (82) is further configured to:
receive a control element including at least one of:
a first TA indication and a second TA indication;
at least one TAG identifier mapped to one of the first and second TA indications;
a first bitfield indicating whether a TA offset is to be updated for at least one of a third TA and a fourth TA; and
a second bitfield indicating which one of the third and fourth TAs is to be updated.

44. The WD (22) of any one of claims 31-43, wherein performing the at least one TA action by the WD (22) includes:
adjusting uplink transmission timing for the first and second group of uplink channels and reference signals in the same serving cell based on the information about the first and the second TAGs, respectively; and
causing the radio interface (82) to transmit the first and second group of uplink channels and reference signals using the adjusted uplink transmission timing.

45. The WD (22) of any one of claims 31-44, wherein the radio interface (82) is further configured to:
receive third information about a first TA offset associated with the first TAG and a second TA offset associated to the second TAG.

46. A method in a wireless device, WD (22), configured to communicate with a network node (16), the method comprising:
receiving (S146) a configuration for the WD (22) to perform at least one timing advance, TA, action for first and second groups of uplink physical channels and reference signals, the received configuration including information about first and second TA groups, TAGs, the first and second TAGs being associated with the first and the second groups of uplink physical channels and reference signals, respectively, the first and second TAGs being for a same serving cell; and
performing (S148) the at least one TA action based on the received configuration.

47. The method of claim 46, wherein the method further includes:
receiving at least one of:
a first TA command, TAC, associated to the first TAG; and
a second TAC associated to the second TAG.

48. The method of claim 47, wherein the first TAC includes first information about a first TA, and the second TAC includes second information about a second TA.

49. The method of any one of claims 47 and 48, wherein the first and the second groups of uplink channels and reference signals are transmitted towards a first transmission reception point, TRP, and a second TRP, respectively.

50. The method of claim 49, wherein the first TAG and the second TAG are associated with at least one of:
a first TA reference timing and a second TA reference timing, respectively;
a first TA offset indication and a second TA offset indication, respectively; and
a first TA timer and a second TA timer, respectively.

51. The method of claim 50, wherein the first and the second TA offset indications are configured for the WD (22) by the network node (16).

52. The method of any one of claims 50 and 51, wherein the method further includes receiving at least one of:
a first downlink reference signal from the first TRP; and
a second downlink signal from the second TRP, the first and second downlink signals being usable by the WD (22) to determine the first TA reference timing and the second TA reference timing, respectively.

53. The method of any one of claims 50-52, wherein the received configuration further includes at least a first control resource set, CORESET, with a first CORESET pool index and a second CORESET with a second CORESET pool index, the first CORESET pool index being associated with the first TAG, the second CORESET pool index being associated with the second TAG.

54. The method of claim 53, wherein method further includes:
receiving signaling associated with at least one of the first and second CORESET pool indices, the transmitted signaling being usable by the WD (22) to determine the first TA reference timing for the first TAG associated with the first TRP and the second TA reference timing for the second TAG associated with the second TRP, respectively.

55. The method of any one of claims 53 and 54, wherein the first and second groups of uplink physical channels and reference signals are associated with the first and second CORESET pool indices, respectively.

56. The method of any one of claims 46-55, wherein the received configuration further comprises a list of transmission configuration indicator, TCI, states, and each TCI state of the list of TCI states is associated with one of the first and second TAGs.

57. The method of claim 56, wherein each one of the first and second groups of uplink physical channels and reference signals is associated with one TCI state of the list of TCI states.

58. The method of any of claims 46-57, wherein the method further includes:
receiving a control element including at least one of:
a first TA indication and a second TA indication;
at least one TAG identifier mapped to one of the first and second TA indications;
a first bitfield indicating whether a TA offset is to be updated for at least one of a third TA and a fourth TA; and
a second bitfield indicating which one of the third and fourth TAs is to be updated.

59. The method of any one of claims 46-58, wherein performing the at least one TA action by the WD (22) includes:
adjusting uplink transmission timing for the first and second group of uplink channels and reference signals in the same serving cell based on the information about the first and the second TAGs, respectively; and
transmitting the first and second group of uplink channels and reference signals using the adjusted uplink transmission timing.

60. The method of any one of claims 46-59, wherein the method further includes:
receiving third information about a first TA offset associated with the first TAG and a second TA offset associated to the second TAG.
